(19) United States
(12) Patent Application Publication
(10) Pub. No.: US 2023/0379870 A1
(43) Pub. Date: Nov. 23, 2023

(54) SYSTEM INCLUDING A SERVER SYSTEM, A PLURALITY OF GATEWAYS AND A PLURALITY OF OBJECTS

(71) Applicant: MOECO IOT INC., Los Altos, CA (US)

(72) Inventors: Dmitry GORILOVSKY, Berlin (DE); Ilia ASTAFEV, Los Altos, CA (US); Oleksandra SYNIACHEVA, Berlin (DE); Anton KUROPYATNIK, Los Altos, CA (US)

(21) Appl. No.: 18/248,192

(22) PCT Filed: Oct. 6, 2021
(86) PCT No.: PCT/US2021/053700

§ 371 Date: Apr. 6, 2023

(30) Foreign Application Priority Data
Oct. 6, 2020 (GB) 2015803.6

(51) Int. Cl. H04W 64/00

(52) U.S. Cl. CPC H04W 64/006; H04W 88/16

(57) ABSTRACT

A system for tracking a plurality of objects, including a server system and gateways, wherein each object includes a battery arranged to power it, a non-transitory storage medium, an object ID stored in the storage medium, a first transceiver and a second transceiver, wherein the second transceiver is different to the first transceiver and the first transceiver of each object is arranged to communicate with a first respective gateway, and wherein the second transceiver of each object is arranged to communicate with a second respective gateway. Each object includes at least one sensor and is configured to sense and transmit sensory data. The server system is configured to store a tracking record of each respective object in association with the respective object ID.

### BACKGROUND OF THE INVENTION

### 1. Field of the Invention

The field of the invention relates to systems including a server system, a plurality of gateways and a plurality of objects, and to related methods and computer program products.

### 2. Technical Background

Asset (or Object) Tracking enables tracking the location of objects at any given time and keeping a log of their position changes. Asset (or Object) Tracking may provide inventory of industrial assets (or objects) in a warehouse, industrial assets (or objects) at a construction site, industrial assets (or objects) at a drilling site and so on.

However, there is a need to decide whether to inspect, maintain or replace assets (or objects) when really needed, instead of making scheduled inspections, to reduce maintenance costs and/or activities. Therefore, improved Asset (or Object) Tracking is desirable.

### 3. Discussion of Related Art

EP2670108A1 and EP2670108B1 each discloses a pluggable module, which module is configured to be connected into a pluggable port of a radio base station. The pluggable module is associated with at least one sensor for collecting external sensor data. The pluggable module comprises at least one communication interface, a processor and a memory for storing software comprising computer program code which, when run in the processor, causes the pluggable module to collect pre-specified external sensor data from at least one sensor associated with the pluggable module and communicate the collected external sensor data to a centralized server via the at least one communication interface.

### SUMMARY OF THE INVENTION

According to a first aspect of the invention, there is provided a system for tracking a plurality of objects, the system including a server system, a plurality of gateways and the plurality of objects, wherein each object of the plurality of objects includes a battery arranged to power the object, a non-transitory storage medium, an (e.g. unique) object ID stored in the non-transitory storage medium, a first transceiver and a second transceiver, wherein the second transceiver is different to the first transceiver, wherein the first transceiver of each object is arranged to communicate with a first respective gateway, and wherein the second transceiver of each object is arranged to communicate with a second respective gateway;
wherein each object of the plurality of objects includes one or a plurality of sensors and is configured to sense and to transmit sensory data, wherein the server system is configured to receive transmissions of the sensory data from each respective object via any gateway of the plurality of gateways, the transmissions including a respective object ID of a respective object, and a gateway ID of a gateway which receives the transmission from the respective object and which sends the transmission to the server system;
wherein the server system is configured to store a tracking record of each respective object in association with the respective object ID, wherein the server system is configured to update the stored tracking record of the respective object, in response to receiving a respective communication from the respective object, the update including the sensory data and location data of the respective object;
wherein the server system is configured to derive the location data of the respective object using at least a gateway ID included in the received communication from the respective object. The second transceiver is different to the first transceiver in that they use different transceiver technologies: for example, the second transceiver is a LoRa (Long Range) transceiver and the first transceiver is a Bluetooth Low Energy transceiver. An advantage is reduced maintenance costs and/or activities in respect of the plurality of objects.

The system may be one wherein the first transceiver is arranged to communicate with the first respective gateway over a distance up to at least 20 m. An advantage is that battery power may be conserved, because the distance over which communication is provided is limited.

The system may be one wherein the first transceiver is a Bluetooth transceiver or a Bluetooth Low Energy transceiver. An advantage is that battery power may be conserved, because the distance over which communication is provided is limited.

The system may be one wherein the first transceiver is arranged to communicate with the first respective gateway over a distance up to at least 1.0 km. An advantage is that battery power may be conserved, because the distance over which communication is provided is limited.

The system may be one wherein the first transceiver is a Bluetooth Long Range transceiver. An advantage is that battery power may be conserved, because the distance over which communication is provided is limited.

The system may be one wherein the second transceiver is arranged to communicate with the second respective gateway over a distance up to at least 10 km. An advantage is that the second transceiver may be used, if the first transceiver is not within reception range of a first respective gateway.

The system may be one wherein the second transceiver is a LoRa (Long Range) transceiver. An advantage is that the second transceiver may be used, if the first transceiver is not within reception range of a first respective gateway.

The system may be one wherein the second transceiver is a cellular transceiver and the second respective gateway is a cellular gateway. An advantage is that the second transceiver may be used, if the first transceiver is not within reception range of a first respective gateway.

The system may be one wherein the cellular transceiver and the cellular gateway technology is 2G(GPRS), or 3G, or NarrowBand-Internet of Things (NB-IoT), or LTE Cat. M ((Long Term Evolution for Machines-low power wide area (LPWA))), or 5G.

The system may be one wherein each object includes a unique object ID and can be identified through an included identifier which is an included Radio-frequency identification (RFID) tag, or an included NFC tag, or an included Quick Response code (QR code) or an included barcode, wherein the included identifier includes the unique object ID. An advantage is that each object may be readily identified by examination using a suitable scanning device.

The system may be one wherein the objects each include a temperature sensor, the sensory data includes temperature data measured using the temperature sensor, and the update includes the temperature data of the respective object. An advantage is that undesirable temperature excursions of the objects may be identified.

The system may be one wherein the objects each include a light sensor, the sensory data includes light exposure data measured using the light sensor, and the update includes the light exposure data of the respective object. An advantage is that undesirable light exposures of the objects may be identified.

The system may be one wherein the objects each include a noise sensor, the sensory data includes noise data measured using the noise sensor, and the update includes the noise data of the respective object. An advantage is that a hearing dose of individuals close to the object may be evaluated, for evaluating hearing dose safety.

The system may be one wherein the objects each include an accelerometer sensor, the sensory data includes vibration data measured using, or derived from, the accelerometer sensor, and the update includes the vibration data of the respective object. An advantage is that maintenance requirements based on cumulative operation time of a monitored object may be evaluated. An advantage is that maintenance requirements based on cumulative operation time of a monitored object may be evaluated, weighted according to workload during operation time.

The system may be one wherein the sensory data includes sensory data derived from the accelerometer sensor which is Fast Fourier Transform of vibration data measured using the accelerometer sensor. An advantage is that battery power of the object may be saved, because the transmitted data is reduced.

The system may be one wherein the objects each include a pressure sensor, the sensory data includes pressure data measured using the pressure sensor, and the update includes the pressure data of the respective object. An advantage is that damage due to undesirable pressure exposures of the objects may be identified. An advantage is that periods of airborne transportation of the objects may be identified.

The system may be one wherein the objects each include a water immersion sensor, the sensory data includes water immersion data measured using the water immersion sensor, and the update includes the water immersion data of the respective object. An advantage is that maintenance of objects which can be submersed in water can be better planned for.

The system may be one wherein the server system is configured to analyze received sensory data of a respective object, and to determine whether to inspect, maintain or replace the respective object, and to record the determination. An advantage is that maintenance costs and/or activities can be reduced.

The system may be one wherein the server system includes a data collection, transmission and visualization platform, which also includes data orchestration, analytics and integration with other systems. An advantage is that data relating to the objects can be compiled from a variety of sources, to improve maintenance activities.

The system may be one wherein the platform includes a visual editing tool, the tool operable to define zones, and operable to place one or both of directional and omnidirectional beacons, e.g. in a map or location plan. An advantage is improved accuracy of location data of the objects.

The system may be one wherein the tool is operable to define the place of beacons on a map or location plan, to include their geographic or relative coordinates, to define geofences, and to save this data in a (e.g. Moeco) geolocation service. An advantage is improved accuracy of location data of the objects.

The system may be one wherein the plurality of gateways do not perform any data-related operations. An advantage is reduced risk of tampering with the data sent from the objects to the server system.

The system may be one wherein the server system is configured to include a list of objects at a site, such as at a warehouse, at a construction site, or at a drilling site. An advantage is an improved record of the objects at a site.

The system may be one wherein the server system is configured to output positions of the objects in the list of objects. An advantage is an improved record of the objects at a site.

The system may be one wherein the server system is configured to output the usage of each object in the list of objects, for example using sensed vibration data. An advantage is an improved record of the objects at a site.

The system may be one wherein the objects are included in pallets, or are included in consumable parts for industrial water desalination plants.

The system may be one wherein each object is configured to receive an instruction to go into a deep sleep state, and to go into the deep sleep state, in response to receiving the instruction to go into the deep sleep state. An advantage is saving of battery power.

The system may be one wherein each object is customizable and includes multiple pads and/or connectors arranged to mount or to connect sensors, e.g. during tracker customisation. An advantage is that objects can be re-purposed, after a first period of usage.

The system may be one wherein the plurality of sensors includes two or more of, or all of: (a) an Air/Surface temperature sensor; (b) a humidity sensor; (c) an accelerometer (e.g. for sensing Vibrational patterns, movements detection, orientation in space); (d) a Magnetometer (e.g. for sensing Direction of movement/facing); (e) a light exposure sensor; (f, an air pressure sensor; (g) a distance sensor; (h) a Secure seal. An advantage is that the objects may be used for many purposes.

The system may be one wherein each object is configured to determine its location, for example using one or more of: (a) Global Positioning System (GPS)/Global navigation satellite system (GNSS) coordinates; or
(b) Triangulation by cellular network (e.g. GSM) Towers; or
(c) Triangulation through gateways locations; or
(d) WiFi or Bluetooth location-based service (LBS); or
(e) Bluetooth 5.1 Angle of Arrival (AoA) and/or Angle of Departure (AoD) calculating; Or
(f) Bluetooth location beacons zoning (half-sphere and/or omnidirected); or
(g) RFID zoning. An advantage is improved accuracy of location of an object.

The system may be one wherein each object is configured to measure signals from a plurality of beacons, to determine the beacons' IDs and respective signal attenuation levels, and to transmit the determined beacons' IDs and respective signal attenuation levels to the server system, wherein the server system is configured to derive location data of the respective object using the transmitted determined beacons' IDs and the respective signal attenuation levels. An advantage is improved accuracy of location of an object.

The system may be one wherein the plurality of gateways are configured to receive the same signal from an object, and to determine a respective signal attenuation level, and to transmit the received signal and the determined respective signal attenuation level to the server system, wherein the server system is configured to derive location data of the respective object using the received signals and the determined respective signal attenuation levels. An advantage is improved accuracy of location of an object.

The system may be one wherein one, two or more directional bluetooth beacons are included in the system. An advantage is improved accuracy of location of an object.

The system may be one wherein the server system is configured to determine a frequency (i.e. how often) for sending data from the object to the server system, and to configure the object to send the data at the determined frequency for sending data from the object to the server system. An advantage is saving of battery power.

The system may be one wherein an object is configured to wake up from a sleep state and to transmit sensory data to the server system in response to one or more of, or all of: (a) one or several timers indicating it is time to wake up; (b) movement or vibration being detected; (c) sensory input detection, such as from light exposure, noise, temperature, humidity; (d) when a list of detected beacons changes. An advantage is saving of battery power.

The system may be one wherein each object of the plurality of objects includes ingress protection. An advantage is improved object robustness.

The system may be one wherein the server system stores the current state of the plurality of objects, and wherein the server system is configured to display a dashboard of the plurality of objects, showing the current state of the plurality of objects. An advantage is improved tracking of the objects.

The system may be one wherein the server system includes a Peer-to-peer distributed network, or a Private distributed network, or a Network of isolated clusters.

The system may be one wherein the server system includes a Data Transfer Network which is configured to collect, synchronize and store immutably transferred encrypted transmissions. An advantage is improved security of stored data with respect to the objects.

The system may be one wherein the server system includes a Data Transfer Network which is configured to collect, synchronize and store immutably transferred encrypted metadata, such as a list of the sensors identified by their IDs that are sensed by the object, and/or object settings, and/or a list of the gateways sensed by the object. An advantage is improved security of stored data with respect to the objects.

The system may be one wherein the Data Transfer Network includes one or more, or all, of: Blockchain Nodes; Regular data storage; and an Administrative console. An advantage is improved security of stored data with respect to the objects.

The system may be one wherein the Administrative console is configured to execute Structured Query Language (SQL) queries on the Regular data storage using data from the Blockchain nodes stored on the Regular data storage.

The system may be one wherein the server system stores a layout of zones and objects on a location plan and/or map, and is configured to display an object tracking dashboard configured to display the layout of zones and objects on the location plan and/or map. An advantage is improved tracking of the objects.

The system may be one wherein the server system is configured to calculate a list of stages in the life cycle of an object, and (e.g. basic) statistics about the number of objects in these stages and their movements between stages, and is configured to display the calculated results on an object tracking dashboard. An advantage is improved tracking of the objects.

The system may be one wherein the server system is configured to output inventory lists of objects located in a location, by object type, along with available information, such as the planned date of maintenance of each object, and/or the previous date of maintenance of each object, and to display this information on an object tracking dashboard. An advantage is improved tracking of the objects.

The system may be one wherein the server system is configured to determine a distribution of objects at different stages of the object life cycle, along with information about the current object state and mode of object use at each life cycle stage, and to display this information on an object tracking dashboard. An advantage is improved tracking of the objects.

According to a second aspect of the invention, there is provided a computer-implemented method for tracking a plurality of objects using a system, the system including a server system, a plurality of gateways and the plurality of objects, wherein each object of the plurality of objects includes a battery arranged to power the object, a non-transitory storage medium, an (e.g. unique) object ID stored in the non-transitory storage medium, a first transceiver and a second transceiver, wherein the second transceiver is different to the first transceiver, wherein the first transceiver of each object is arranged to communicate with a first respective gateway, and wherein the second transceiver of each object is arranged to communicate with a second respective gateway; wherein each object of the plurality of objects includes one or a plurality of sensors and is configured to sense and to transmit sensory data;
the method including the steps of:
(i) each object sensing and transmitting the sensory data;
(ii) the server system receiving transmissions of the sensory data from each respective object via the first respective gateway, and via the second respective gateway, the transmissions including a respective object ID of a respective object, and a gateway ID of a gateway which receives the transmission from the respective object and which sends the transmission to the server system;
(iii) the server system deriving location data of the respective object using at least a gateway ID included in the received communication from the respective object;
(iv) the server system storing a tracking record of each respective object in association with the respective object ID, and updating the stored tracking record of the respective object, in response to receiving a respective communication from the respective object, the update including the sensory data and the location data of the respective object. The second transceiver is different to the first transceiver in that they use different transceiver technologies: for example, the second transceiver is a LoRa (Long Range) transceiver and the first transceiver is a Bluetooth Low Energy transceiver. An advantage is reduced maintenance costs and/or activities in respect of the plurality of objects.

The method may be one using a system of any aspect according to the first aspect of the invention.

According to a third aspect of the invention, there is provided a method of tracking an object, the method including the steps of:
(i) attaching a tracking device to the object, the tracking device including a battery arranged to power the tracking device, and a unique ID stored in a non-transitory storage medium;
(ii) collecting tracking data from the tracking device, and sending the tracking data to a server system for storage in a tracking record of the object, the tracking record including the unique ID, in a computer-implemented step;
(iii) searching for an object at a location, by searching for the unique ID of the tracking device, using a portable device (e.g. a smartphone or hand-held scanner) in communication with the server system, and receiving location data for the object from the server system using the tracking device tracking record, in a computer-implemented step. An advantage is improved tracking of an object.

The method may be one including the step of: (iv) performing maintenance of the object, including optionally replacing the tracking device, and attaching a replacement tracking device to the object, the replacement tracking device including a unique ID, and storing the unique ID of the replacement tracking device in the tracking record of the object. An advantage is reduced maintenance requirements for the tracking device.

The method may be one wherein step (i) includes the computer-implemented step of an ID (e.g. RFID, NFS, QR or Barcode) of the tracking device being scanned using a portable device, e.g. smartphone executing an associated smartphone application, or using a handheld RFID scanner, and the portable device sending the ID of the tracking device to the server system. An advantage is improved tracking of the object.

The method may be one wherein a serial number of the object is recorded, or is generated automatically.

The method may be one wherein the method includes the computer-implemented step of: the data received from the tracker is compared with previously received data from trackers on the same type of object, in the same modes of use, and an alert is triggered in response to a deviation from the previously received data, wherein the deviation is above a threshold. An advantage is reduced maintenance inspection requirements for the object.

The method may be one wherein the method includes the step of: collecting manual maintenance data of the object, and the method including the computer-implemented steps of transmitting the collected manual maintenance data of the object to the server system, and the server system using the collected manual maintenance data of the object to predict a reduction in the object lifetime. An advantage is reduced maintenance inspection requirements for the object.

The method may be one wherein the method uses a system of any aspect of the first aspect of the invention.

According to a fourth aspect of the invention, there is provided a computer program product, the computer program product executable on a portable scanner (e.g. a smartphone) including a screen to:
(i) read a unique ID of a tracking device associated with an object, such as using a Radio-frequency identification (RFID) tag, or a NFC tag, or a Quick Response code (QR code) or barcode;
(ii) search for an object, by searching for the unique ID of the tracking device, including communicating with a server system, and receiving location data for the object from the server system using a tracking device tracking record stored on the server system and corresponding to the unique ID of the tracking device;
(iii) obtain data about the object from the server system, using the unique ID, and
(iv) display the data about the object from the server system on the screen of the portable scanner.

An advantage is improved tracking of the object.

The computer program product may be one wherein the computer program product is executable on a portable scanner to:
(iv) replace the unique ID of the tracking device, with a unique ID of a replacement tracking device associated with the object, and to store service history of the object associated with servicing work of the object at the server system. An advantage is reduced maintenance requirements for the tracking device.

According to a fifth aspect of the invention, there is provided a system for tracking a plurality of objects, the system including a server system, a plurality of gateways and the plurality of objects, wherein each object of the plurality of objects includes a battery arranged to power the object, a non-transitory storage medium, an (e.g. unique) object ID stored in the non-transitory storage medium, and a transceiver, wherein the transceiver of each object is arranged to communicate with the gateways;
wherein each object of the plurality of objects includes one or a plurality of sensors and is configured to sense and to transmit sensory data, wherein the server system is configured to receive transmissions of the sensory data from each respective object via any gateway of the plurality of gateways, the transmissions including a respective object ID of a respective object, and a gateway ID of a gateway which receives the transmission from the respective object and which sends the transmission to the server system; wherein the server system is configured to store a tracking record of each respective object in association with the respective object ID, wherein the server system is configured to update the stored tracking record of the respective object, in response to receiving a respective communication from the respective object, the update including the sensory data and location data of the respective object;
wherein the server system is configured to derive the location data of the respective object using at least a gateway ID included in the received communication from the respective object. An advantage is improved tracking of the plurality of objects.

The system may be one wherein the objects each include a built-in clock, and clock data is transmitted together with the sensory data by each object to the server system. An advantage is that tracking of the plurality of objects is improved.

The system may be one wherein the transceiver is arranged to communicate with a gateway over a distance up to at least 20 m. An advantage is that battery power may be conserved, because the distance over which communication is provided is limited.

The system may be one wherein the transceiver is a Bluetooth transceiver. An advantage is that battery power may be conserved.

The system may be one wherein the Bluetooth transceiver is configurable to operate as a Bluetooth Low Energy transceiver. An advantage is that battery power may be conserved.

The system may be one wherein the Bluetooth transceiver is configurable to operate as a Bluetooth Long Range transceiver. An advantage is that battery power may be conserved, because the distance over which communication is provided is limited.

The system may be one wherein at least one gateway of the plurality of gateways includes a (e.g. rechargeable) battery arranged to power the at least one gateway, a non-transitory storage medium, an (e.g. unique) ID stored in the non-transitory storage medium, and wherein the at least one gateway includes one or a plurality of sensors and is configured to sense and to transmit sensory data, wherein the server system is configured to receive transmissions of the sensory data from the at least one gateway, the transmissions including the ID of the at least one gateway;
wherein the server system is configured to store a tracking record of the at least one gateway in association with its ID, wherein the server system is configured to update the stored tracking record of the at least one gateway, in response to receiving a respective communication from the at least one gateway, the update including the sensory data and location data of the at least one gateway;
wherein the server system is configured to derive the location data of the at least one gateway using at least the ID of the at least one gateway included in the received communication from the at least one gateway. An advantage is that sensor data may be transmitted to the server system, without modifying the transceivers of the plurality of objects to transmit over a greater distance.

The system may be one wherein a gateway, such as the at least one gateway, adds position data to the data it transmits to the server system, in which the position data is obtained by the gateway scanning for WiFi or Mobile networks or via a built-in GNSS or GPS receiver. An advantage is that tracking of the plurality of objects is improved.

The system may be one wherein the at least one gateway includes a built-in clock, and clock data is transmitted together with the sensory data by the at least one gateway to the server system. An advantage is that tracking of the plurality of objects is improved.

The system may be one wherein the at least one gateway includes a cellular transceiver and determines its location by triangulation using cellular (e.g. GSM) base stations, and transmits its determined location to the server system. An advantage is that tracking of the plurality of objects is improved.

The system may be one wherein the at least one gateway includes a WiFi transceiver and determines its location using WiFi access points it detects, and transmits its determined location to the server system. An advantage is that tracking of the plurality of objects is improved.

The system may be one wherein the plurality of sensors of the at least one gateway includes two or more of, or all of: (a) an Air/Surface temperature sensor; (b) a humidity sensor; (c) an accelerometer (e.g. for sensing physical shock); (d) a light measurement sensor; (e) a position sensor; (f) a tamper sensor. An advantage is that the objects may be used for many purposes.

The system may be one wherein the at least one gateway includes a temperature sensor, the sensory data includes temperature data measured using the temperature sensor, and the update includes the temperature data of the at least one gateway. An advantage is that undesirable temperature excursions of the at least one gateway may be identified.

The system may be one wherein the at least one gateway includes a light sensor, the sensory data includes light measurement data measured using the light sensor, and the update includes the light measurement data of the at least one gateway. An advantage is that undesirable light exposures of the at least one gateway may be identified.

The system may be one wherein the at least one gateway includes an accelerometer sensor, the sensory data includes shock data measured using, or derived from, the accelerometer sensor, and the update includes the shock data of the at least one gateway. An advantage is that rough handling of the at least one gateway may be identified.

The system may be one wherein the system includes a system of any aspect of the first aspect of the invention.

Aspects of the invention may be combined.

### BRIEF DESCRIPTION OF THE FIGURES

Aspects of the invention will now be described, by way of example(s), with reference to the following Figures, in which:

FIG. 1 shows examples of operational modes, for a monitored asset (or object).

FIG. 2 shows an example of a tracker device, e.g. a Moeco tracker device, in an exploded diagram for (a) a bottom view, and (b) a top view.

FIG. 3 shows an example of a tracking device including a complex shaped film antenna, in an exploded diagram of the tracking device.

FIG. 4 shows an example of a housing including an internal antenna, in which the internal antenna is not shown.

FIG. 5 shows an example of a housing and an external antenna.

FIG. 6 shows example polar field diagrams for (a) directional and (b) omnidirectional beacons.

FIG. 7 shows an example of directional beacons allocation, in which the directional beacons are in use.

FIG. 8 shows an example flow diagram of states of a tracking device, where BT is Bluetooth, and the Tᵢ are time periods.

FIG. 9 shows an example of an iron tube including an attached tracker.

FIG. 10 shows an example of a pallet including an attached tracker.

FIG. 11 shows a diagram of a software platform, e.g. a Moeco software platform, example.

FIG. 12 shows a diagram of a Peer-to-peer distributed network example.

FIG. 13 shows a diagram of a Private distributed network example.

FIG. 14 shows a diagram of a Network of isolated clusters example.

FIG. 15 shows an example of an administrative console main view, e.g. a Moeco administrative console main view.

FIG. 16 shows an example of a location map and main statistics view.

FIG. 17 shows an example of a smart inventory view.

FIG. 18 shows an example of a life cycle stages statistics view.

FIG. 19 shows an example of an asset (or object) tracking workflow.

FIG. 20 shows an example tracking system.

FIG. 21 shows an exploded diagram of an example data logger device which is in a form-factor of a stick-on label (1, 5—cardboard parts; 2, 4—plastic parts; 3—electronics).

FIG. 22 shows an example light indication of operating state of a device (21—Light indicator; 22—Button).

FIG. 23 shows an example of an installation of a Global Tag device on a belt.

FIG. 24 shows an example of gateway device in (a) a front-and-side perspective view, and in (b) a rear-and-side perspective view.

### DETAILED DESCRIPTION

Smart Asset (or Object) Tracking Basics

What is Asset (or Object) Tracking?

Asset (or Object) Tracking is a solution that allows you to track the location of objects at any given time and keep a log of their position changes. In examples, Asset (or Object) Tracking helps the user to take inventory of industrial assets (or objects) in a warehouse, industrial assets (or objects) at a construction site, industrial assets (or objects) at a drilling site and so on.

What is Smart Asset (or Object) tracking (e.g. Moeco Smart Asset (or Object) tracking)? In an example, in addition to the usual Asset (or Object) Tracking, the (e.g. Moeco) solution presented here allows at any time to determine not only the position of industrial assets (or objects), but also the conditions of their use, such as temperature, position in space, light exposure, noise, vibration or pressure. Using the information received, the Smart Asset (or object) Tracking solution allows you to determine the operational modes of industrial assets (or objects) and also, by detecting mode changes and other events, track the stages of their life cycle. In this way, the system helps to decide whether to inspect, maintain or replace assets (or objects) when really needed, instead of making scheduled inspections: this helps to reduce maintenance costs and/or activities.

Solution Composition

To perform the declared functions, the system includes trackers equipped with various sensors, performs data collection and operates transmission gateways, and includes a data collection, transmission and visualization platform, which also provides data orchestration, analytics and integration with other systems.

A tracker is an electronic device that can include several different sensors and wireless interfaces. Its main purpose is to provide data on the location, condition and use of an asset (or object) to the platform over one or more radio channels.

Gateways are devices that collect radio messages from trackers and send them to the platform e.g. over a 3G or Ethernet connection. In an example, gateways do not perform any data-related operations.

The (e.g. Moeco) platform includes a set of software modules and services that provide e.g. data exchange between various data collection sites, transfer, storage, processing, enrichment and visualization of data, as well as their analytics and integration with other systems. In an example, separate modules of the platform provide control of trackers and data collection gateways, and provide network status monitoring and statistics collection.

### Use Case Examples

Inventory of high pressure industrial assets (or objects) and/or parts at the (e.g. extraction or exploration) wellsite and optimization of the maintenance interval.
1) The (e.g. Moeco) solution allows you to determine the presence or absence of assets (or objects) on the site, as well as determine which zone an asset (or object) is in at any given time, and/or determine the asset's (or object's) approximate location within the zone.
2) Accounting for the time spent in each of the zones allows you to automatically monitor the allowed operating time of each part, generate notifications about upcoming maintenance, predict the amount of service work, and/or the number and type of replacement parts.
3) Taking into account the presence or absence of vibration, a (e.g. Moeco) Smart Asset (or object) Tracking solution allows you to determine how much time each part was in work and how much time the part was at standby. This information allows you to more accurately account for the remaining life of the part and optimize the next maintenance time (e.g. of the part).
4) For an even more detailed calculation of the part's lifetime, the (e.g. Moeco) solution analyzes the received vibration patterns and determines not only whether the part is working or not, but also the exact mode of its use, such as working under low pressure, high pressure or at standby mode.

Different maintenance operational modes may be appropriate for different monitored assets (or objects). Maintenance based on operation time of a monitored asset (or object) may be appropriate. Maintenance based on cumulative operation time of a monitored asset (or object) may be appropriate. Maintenance based on cumulative operation time of a monitored asset (or object) may be appropriate, weighted according to workload during operation time.

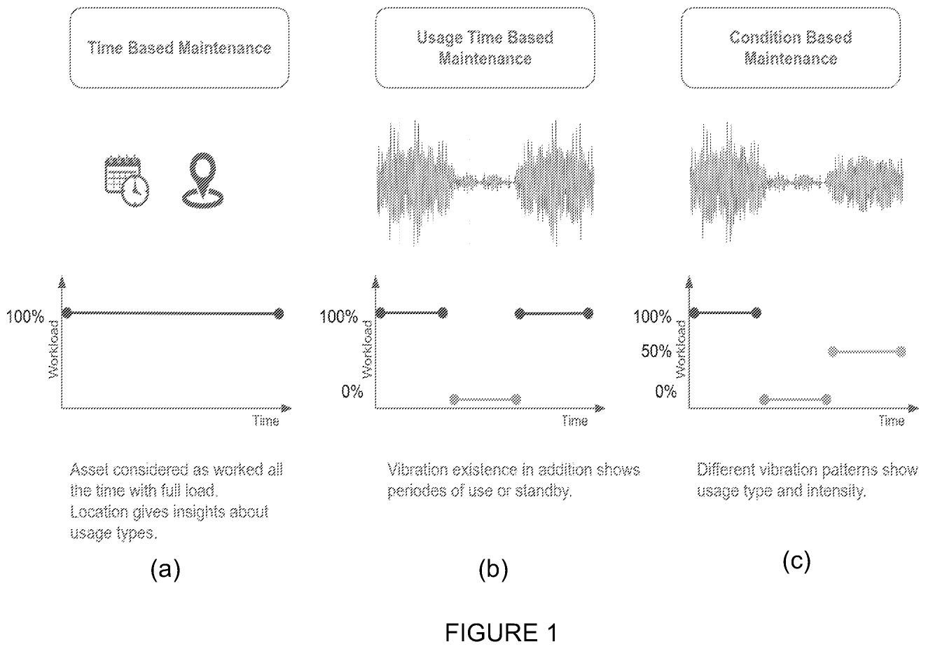

FIG. 1 shows examples of operational modes, for a monitored asset (or object). In (a), maintenance based on operation time of a monitored asset (or object) is appropriate. In (b), maintenance based on cumulative operation time of a monitored asset (or object) is appropriate. In (c), maintenance based on cumulative operation time of a monitored asset (or object) is appropriate, weighted according to workload during operation time.

### Use Case Examples

Inventory of pallets at customer facilities and determining their readiness for use. Objectives include optimization of pallet logistics, and preventing the loss of pallets, for example:
1) The (e.g. Moeco) solution allows you to track the number of pallets located at each customer location.
2) Determining the exact location of a pallet on the site e.g. using LoRa (Long Range) triangulation and Bluetooth Low Energy beacons allows you to determine their states of readiness for use, such as “loaded”, “in a warehouse”, “in a wash or repair”, “free and ready for loading”, etc.
3) Accounting for all pallets immediately after their arrival at a new location allows you to track and optimize chains of movements, as well as identify any pallets lost at each stage.

For the purposes of tracking, (e.g. all) pallets are equipped with trackers that use a local LoRA network to transfer data and determine the approximate location. To clarify the location, the trackers are equipped with a bluetooth sensor that listens to beacons located along the boundaries of the zones.

Using the LoRa network allows you to cover an entire location with only 2-3 base stations, which are installed in the most convenient places, instead of covering the entire area with many gateways.

Meanwhile, Bluetooth Low Energy (BLE) beacons operate on battery power for a long time and can be easily deployed in the required quantity without the need for further infrastructure.

### Use Case Example

Tracking the life cycle of industrial assets (or objects). The company manufactures and supplies consumable parts for industrial water desalination plants, which are designed to be installed and used inside this equipment in conditions of full and prolonged immersion in water.
1) The (e.g. Moeco) solution allows the customer to know where the products are installed and used.
2) The water immersion sensor allows the customer to collect information about the duration of product use and the frequency of routine maintenance. This allows you to optimize warranty performance and to plan replacement proposals.
3) The use of a cellular network for geolocation and data transfer allows (e.g. Moeco) to provide global coverage of trackers, while tracking usage patterns and putting the tracker into a deep sleep state ensures operation on one battery for the entire life of the tracker product.

The (e.g. Moeco) platform, collecting data globally from (e.g. all) trackers, provides the client with an overview of where, in what quantity and how his products are used. Dashboards, reports and notifications allow you to plan and implement proactive actions and communications with users.

### Use Case Example

The company produces sports jackets for different seasons. They would like to make their clothes smart. Thanks to the (e.g. Moeco) solution, sensors added to the jacket allow a number of important metrics to be tracked:
The frequency of use of the jacket
Washing frequency (here you can use a humidity sensor or an acceleration sensor to track spin modes)
Ambient temperature.

In combination with the sensors, there is a mobile application that gives the end user recommendations based on the sensor performance:
the need to wash—the time since the last wash and the number of uses
suggest buying a warmer jacket if the ambient temperature is lower than recommended.

The data (e.g. all the data) received from the sensors is fed to the (e.g. Moeco) platform, accumulated and used for subsequent manual or artificial intelligence (AI) analysis of how end users use their jackets. This will allow the client to better adapt their products to the requirements of consumers.

Asset (or Object) Tracker Description

The tracker can be equipped with a range of sensors and connectivity options depending on the use case, environment and asset (or object) lifecycle.

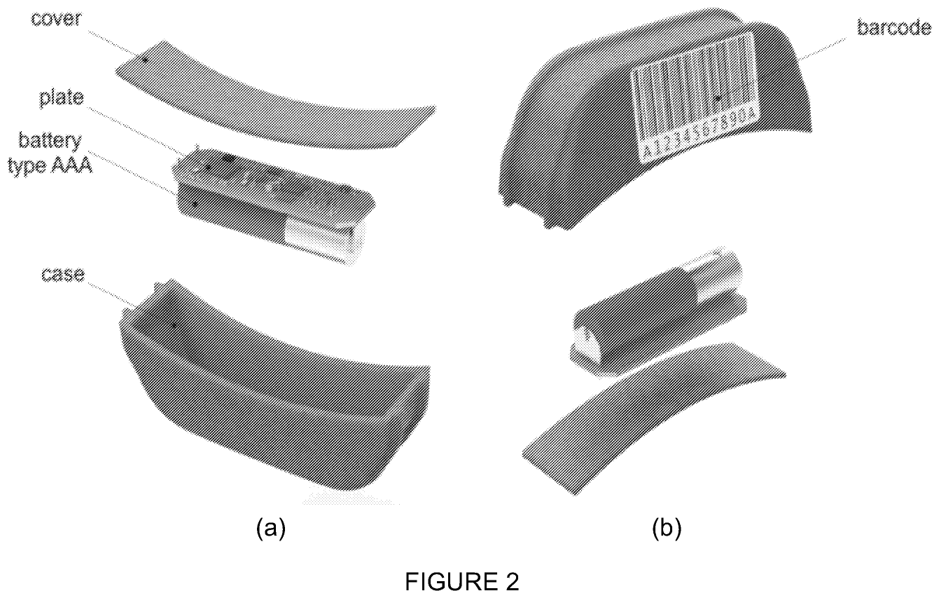

FIG. 2 shows an example of a tracker device, e.g. a Moeco tracker device.

Sensor Options

In an example, the tracker has multiple pads and/or connectors that can be used to mount or connect sensors during the tracker customisation process. The sensors (e.g. all the sensors) can be used to collect data, alert or change the tracker mode based on sensor measurement. There are no restrictions on the type of sensors, but the most common are:
Air/Surface temperature sensor
Humidity sensor
Accelerometer (e.g. for sensing Vibrational patterns, movements detection, orientation in space)
Magnetometer (e.g. for sensing Direction of movement/facing)
Light exposure sensor
Air pressure sensor
Distance sensor
Secure seal

Connectivity Options

An (e.g. Moeco) Asset (or object) Tracker can use several radio connectivity options, depending on the area that should be covered, expected number of sensors, traffic and battery lifetime, for example:
Bluetooth Low Energy

Provides very low power consumption but requires a data transmission gate within a distance of about 20-30 meters from the sensor. It is used for communication with positional beacons, as well as in cases when it is required to cover a small area, for example, one room.
Bluetooth Long Range

Provides a much longer range (e.g. within about 1.0 km) and a greater number of simultaneously connected devices than Bluetooth Low Energy.
LoRa

One LoRa base station provides communication with sensors over an area with a radius of up to 10 km, while remaining very energy efficient and allows the sensor to operate on one battery for up to 10 years. At the same time, the data transfer rate and the number of devices served by one base station are low. Used in cases where you need to provide reliable transmission of a small number of small data packets over a large area. LoRa networks do not require licensing in most countries.
Cellular networks: e.g. 2G(GPRS), 3G, NarrowBand-Internet of Things (NB-LTE Cat. M ((Long Term Evolution for Machines-low power wide area (LPWA))), 5G

Provides global coverage and relatively high-speed connection of an almost unlimited number of sensors (especially when using promising 5G networks).

In most cases, we (e.g. Moeco) combine several different types of connectivity in our sensors. For example, the sensor can have a LoRa or Bluetooth Long Range for toll-free data transmission over the facility, cellular network e.g. Global System for Mobile Communication (GSM) for data transmission when moving between locations and Bluetooth Low Energy for geolocation by beacons. At the same time, the sensor can have a Near-Field Communication (NFC) and/or UCF tag for identification and search. The simultaneous placement of so many antennas in a very compact housing, approximately 4 cm×4 cm×2 cm, is a difficult engineering task. In examples, we (e.g. Moeco) use complex-shaped film antennas, and also bring some of the antennas out to the outer sides of the boxing, depending on the required shape.

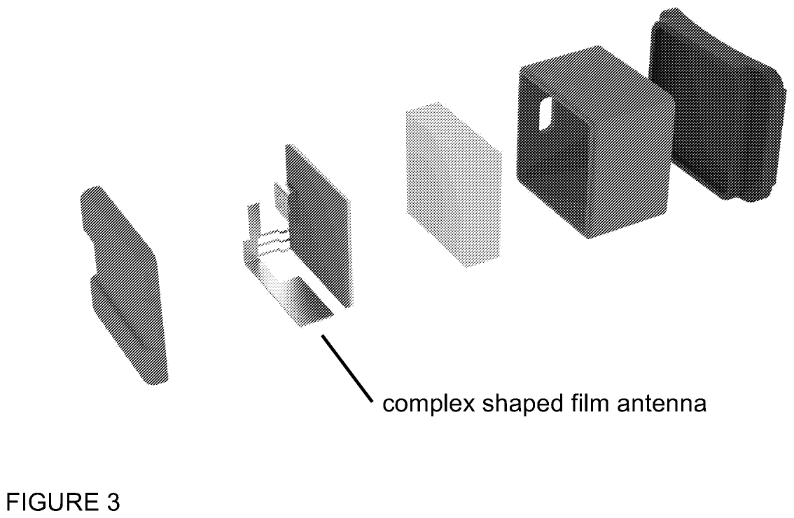

FIG. 3 shows an example of a complex shaped film antenna in a tracking device.

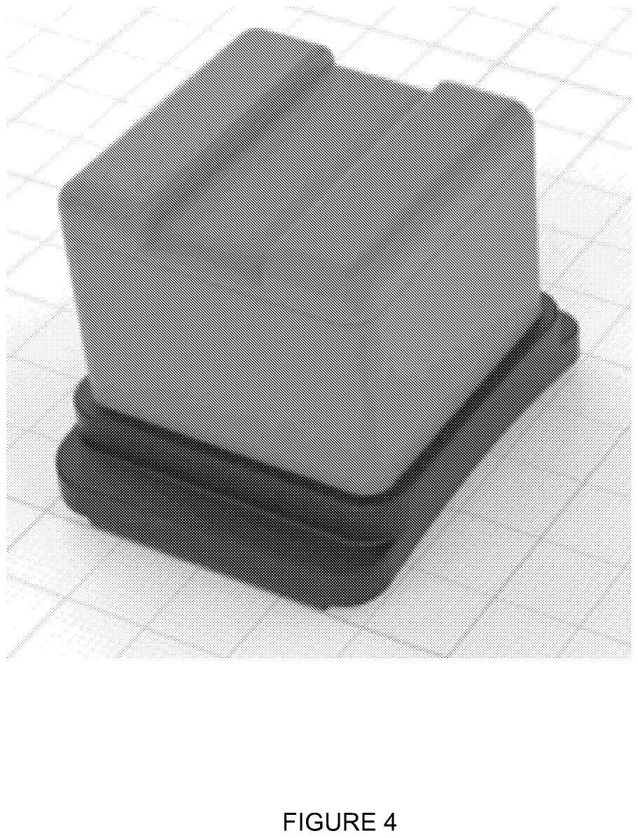

FIG. 4 shows an example of a housing including an internal antenna.

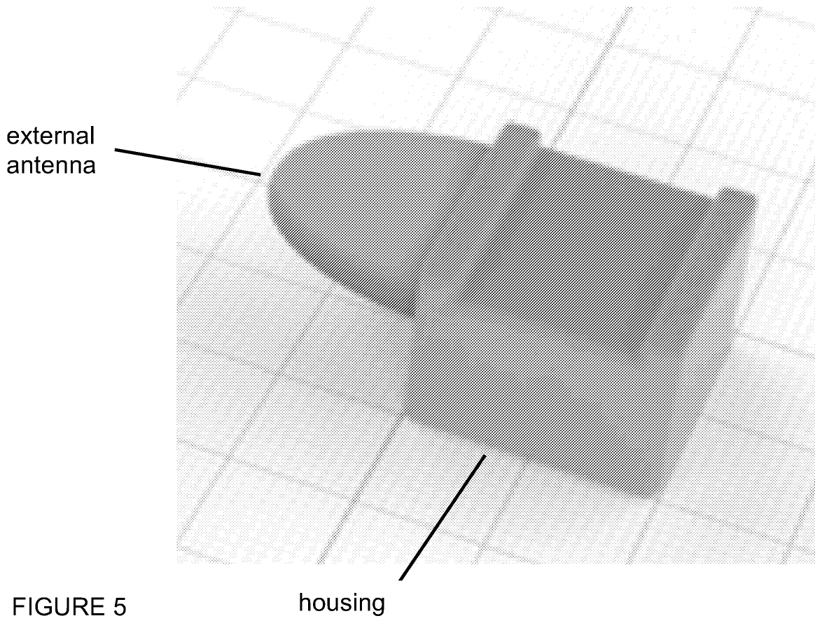

FIG. 5 shows an example of a housing and an external antenna.

Tracker Identification

In examples, trackers (e.g. all trackers) have a unique ID and can be identified e.g. through a Radio-frequency identification (RFID) tag, or a NFC tag, or a Quick Response code (QR code) or barcode, which has the same ID as the tracker. RFID and/or NFC labels are typically mounted inside the tracker meanwhile QR/BarCode labels can be attached to or sticked on its surface.

In an example, our (e.g. Moeco) solution utilises an application for a portable device, e.g. iOS/Android smartphone or Handheld RFID scanner, for the following purposes:
Initial tagging that means mapping tracker with physical asset (or object), where its case has its own unique ID.
Fast searching for a particular tracker over the location.
Get information about asset (or object) and tracker from the platform using a tracker ID.
Process of re-tagging assets (or objects) and storing their history during service works.

Use of RFID makes it easier to add such information to our (e.g. Moeco) database, and use of a QR/BarCode also improves visual identification as well as provides a backup in case of any damage to the electronics of the tracker.

Tracker Geolocation

In examples, the tracker supports one or several types of geolocation services, for example:
Global Positioning System (GPS)/Global navigation satellite system (GNSS) coordinates
Triangulation by cellular network (e.g. GSM) Towers
Triangulation through gateways locations
WiFi or Bluetooth location-based service (LBS)
Bluetooth 5.1 Angle of Arrival (AoA) and/or Angle of Departure (AoD) calculating
Bluetooth location beacons zoning (half-sphere and omnidirected)
RFID zoning.

In addition to the possibility of using GPS, there are two main positioning schemes, for example:
By beacons. Used with e.g. bluetooth beacons, Wi-Fi hotspots, cellular towers. The tracker catches signals from several beacons around in its vicinity, determines their ID and signal attenuation level. The collected information is transmitted to the platform, where the zone a tracker belongs to, or the tracker's (e.g. exact) coordinates, are calculated.

By data transmission gateways. Used with bluetooth and LoRa gateways. Several gateways located around the site receive the same signal from the tracker and determine its attenuation level. Received signals (e.g. all received signals) from gateways (e.g. all gateways) are transmitted to the platform, where the tracker's location is calculated.

In the case when it is necessary to distinguish between trackers located in different zones, but at a short distance from each other, we (e.g. Moeco) use directional bluetooth beacons. Their peculiarity is that the signal level in front of the beacon is much stronger than behind it. Thus, placing two beacons facing each other back by back at the border of two zones allows precise positioning of the tracker.

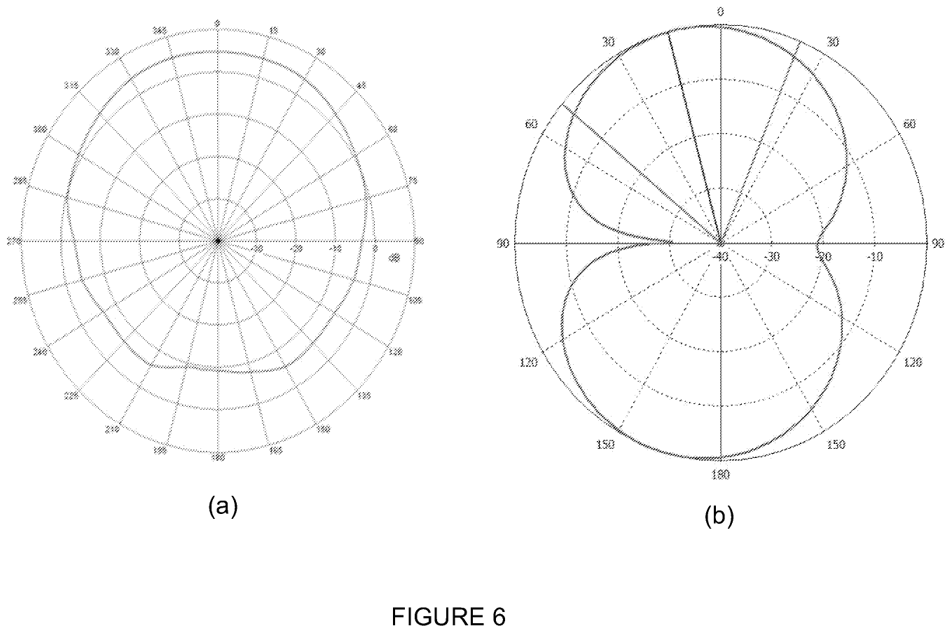

FIG. 6 shows example polar field diagrams for (a) directional and (b) omnidirectional beacons.

Our (e.g. Moeco) platform provides a visual editing tool for zones and placement of both directional and omnidirectional beacons. This tool allows you to place any type of beacons on a map or location plan, get their geographic or relative coordinates and geofence and save this data in the (e.g. Moeco) geolocation service.

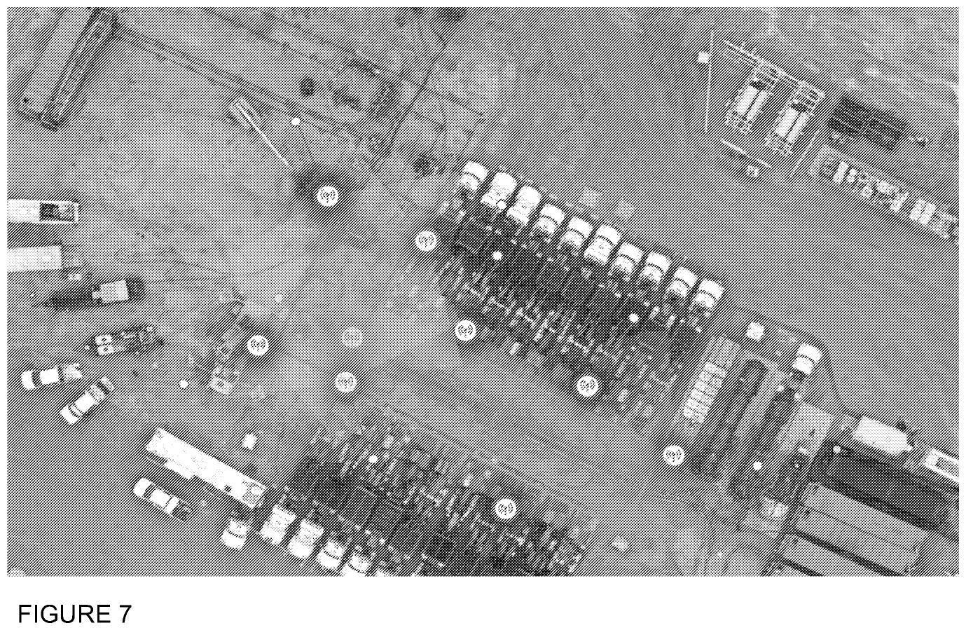

FIG. 7 shows an example of directional beacons allocation.

Power Saving Options

In an example, the tracker is optimized for long life to reduce its own maintenance costs. It can adjust its data schedule based on the condition of the asset (or object) (e.g. based on sensor measurements or location) to save energy (e.g. through deep sleep) while the asset (or object) is idle. Deep sleep can be interrupted by a configurable event—e.g. if the sensor readings go outside set limits.

The tracker also optimizes measurements to reduce the amount of data to transfer without losing any valuable information. For example, the tracker uses Fast Fourier Transform to obtain the most valuable vibration data and shortens data transmission times. The tracker can also reduce airtime by collecting data in the log and transferring the entire log instead of individual chunks of data.

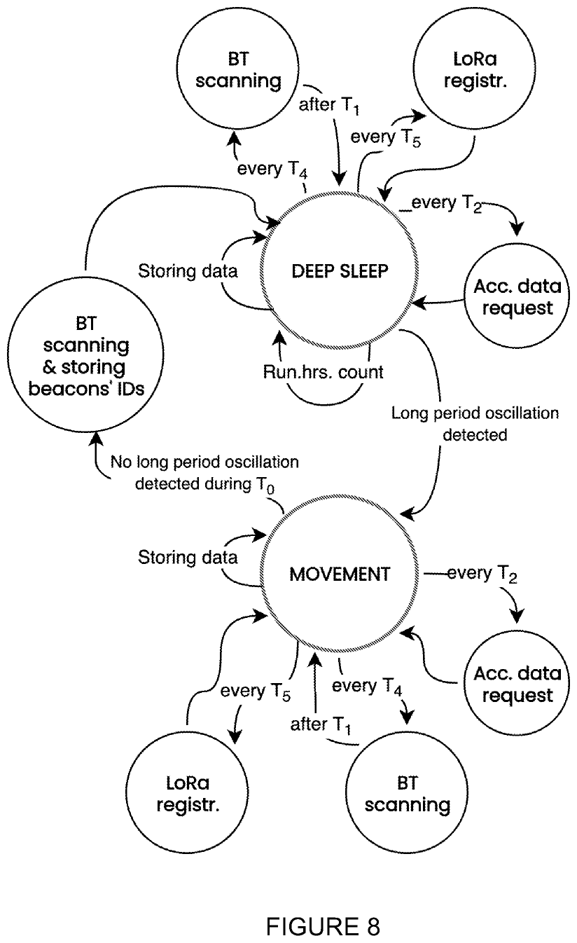

The sensors may use a number of algorithms to save battery power and extend battery life, for example:
Adjustable frequency of sending data from the tracker to the platform (the platform can change the period of sending data to find the optimal frequency).
On edge computing consumes energy, but saves much more energy by reducing the amount of raw data transferred. For instance, fast Fourier transform (FFT) is calculated for the vibration data right on the tracker, thus it reduces the amount of data to transmit. As a result, the transmission time and therefore the energy consumption is reduced.
Sleep and deep sleep modes allow the tracker to switch to energy-saving mode or completely power off part of its modules. Between the phases of collecting, sending data, etc. the tracker goes into sleep or deep sleep according to the state diagram, so the battery consumption is minimized. FIG. 8 shows an example flow diagram of states of a tracking device, where BT is Bluetooth, and the Tᵢ are time periods.
Adjustable events may trigger the tracker activation, such as one or more of:
   Timer. Tracker is able to wake up only necessary modules according to one or several timers.
   Movement or vibration. Tracker changes its mode when movement or vibration is detected.
   Other sensors such as light exposure, noise, temperature, humidity etc.
   Location. Tracker can scan beacons/gateways nearby and wake up when the found beacons list changes.
Reducing the size of the data packet itself by using for instance shortened beacon IDs instead of the standard six byte beacon media access control address (MAC address). Reducing the amount of data transferred leads to shorter communication times and lower energy consumption.

Tracker Configuration Options

Both (e.g. Moeco) Asset (or object) Trackers and a (e.g. Moeco) platform support downlink transactions protocol that can be used for the following one or more purposes:
Configure power saving options such as timings for data measurement, data transferring, deep sleep and other conditions.
Remote activation/deactivation of the tracker.
Order an ad-hoc action such as unscheduled data measure or transition.
perform a firmware upgrade.

Power Supply Options

Depending on the use case, the tracker can be powered by rechargeable or disposable batteries of various capacities and form factors. In some cases, in addition to the battery, energy harvesting devices such as solar panels or Peltier cells can be used. In some cases, trackers can be powered by wire.

### Examples of Casing and Fastening

The (e.g. Moeco) Asset (or object) Trackers can be packaged in a wide range of sizes and shapes. The housing material may be selected in accordance with the intended use cases, environmental conditions, dust/moisture resistance requirements, as well as the required mechanical strength. In most cases, the ingress protection (IP) IP67 standard is supported, and for some versions also IP69 standard is supported. Mechanical strength can be achieved by reinforcing body materials, as well as filling the inner space with a material (e.g. a compound).

Screws, clamps, double-sided tape can be used as fasteners, or fastening can be done with a magnet.

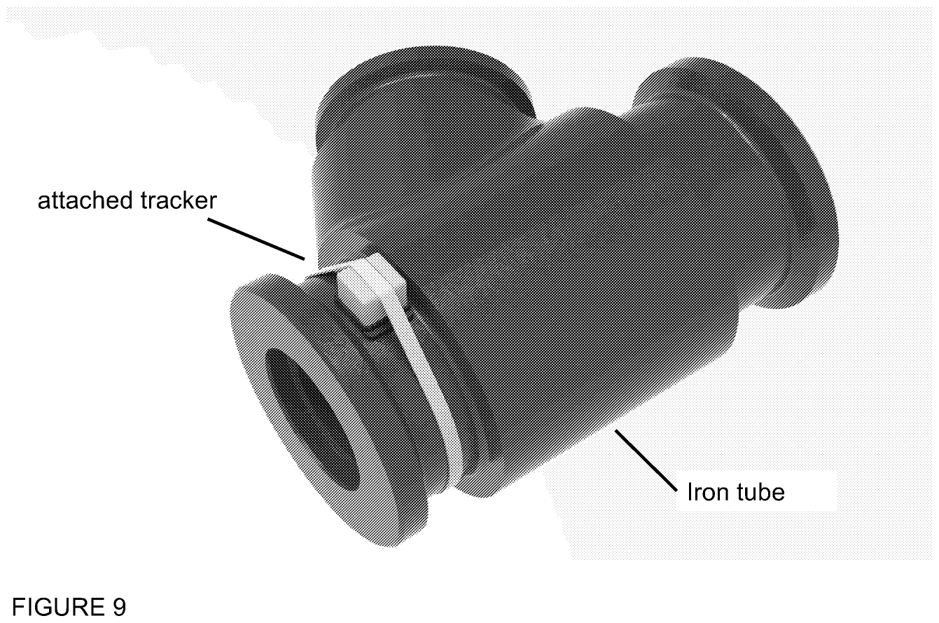

FIG. 9 shows an example of an iron tube including an attached tracker.

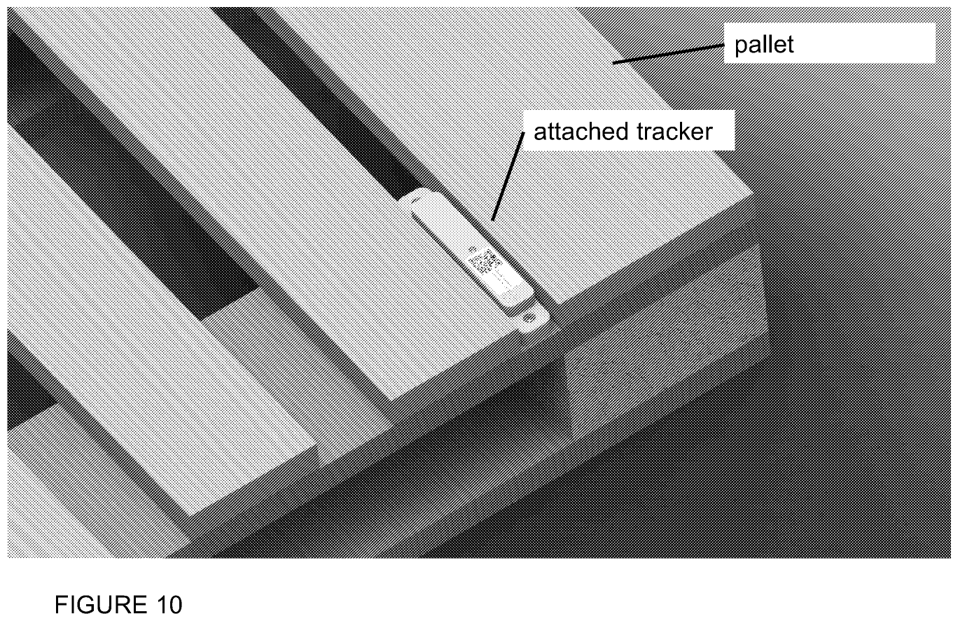

FIG. 10 shows an example of a pallet including an attached tracker.

Platform (e.g. Moeco) Description

In an example, collected data (e.g. all collected data) is transmitted to the (e.g. Moeco) platform, which interprets the sensor data as the current state of assets (or objects) and provides the operator with the simple dashboards of assets (or objects) with the ability to read the entire data. It can determine the current location and condition of an asset (or object) based on tracker data, and determine the current stage of the asset's (or object's) life cycle.

Parts of the (e.g. Moeco) platform can be placed in several different ways, for example:
Locally at the client's location, including placement on industrial computers.
In the client's private cloud
In a provider (e.g. Moeco) private cloud
In the public cloud

In all these cases, deployment may be supported both directly on Linux operating system (OS) and using container technologies.

In an example, sensors transmit sensor data to a plurality of gateways, which may use Bluetooth, LoRa or WiFi technologies, for example. The gateways transmit received sensor data to an edge server (e.g. Moeco edge server). The edge server may include a software gateway and balancer. The edge server may include a decoder. The edge server may include data storage. The edge server may include edge analytics. The edge server may include a dashboard. The edge server may include an admin console. The edge server may include an API. The edge server may include a web server, which may be in connection with one or more, or all, of: local instances of client/third party systems; a web browser in a local network; mobile apps in a local network. The edge server may include a node of a data transfer network, which may be in connection with a cloud platform which may be public or private. The cloud platform may be in connection with one or more of, or all of: a Cloud API, Cloud storage, third party analytics, Cloud instances of client/third party systems, cloud dashboards, cloud admin console. The cloud platform may be in connection with other local instances each including an edge server. Each local instance including an edge server may comprise sensors transmitting sensor data to a plurality of gateways, which may use Bluetooth, LoRa or WiFi technologies, for example, wherein the gateways transmit received sensor data to the local instance edge server (e.g. Moeco edge server). The local instance edge server may include a software gateway and balancer. The local instance edge server may include a decoder. The local instance edge server may include data storage. The local instance edge server may include edge analytics. The local instance edge server may include a dashboard. The local instance edge server may include an admin console. The local instance edge server may include an API. The local instance edge server may include a web server, which may be in connection with one or more, or all, of: local instances of client/third party systems; a web browser in a local network; mobile apps in a local network. The local instance edge server may include a node of a data transfer network.

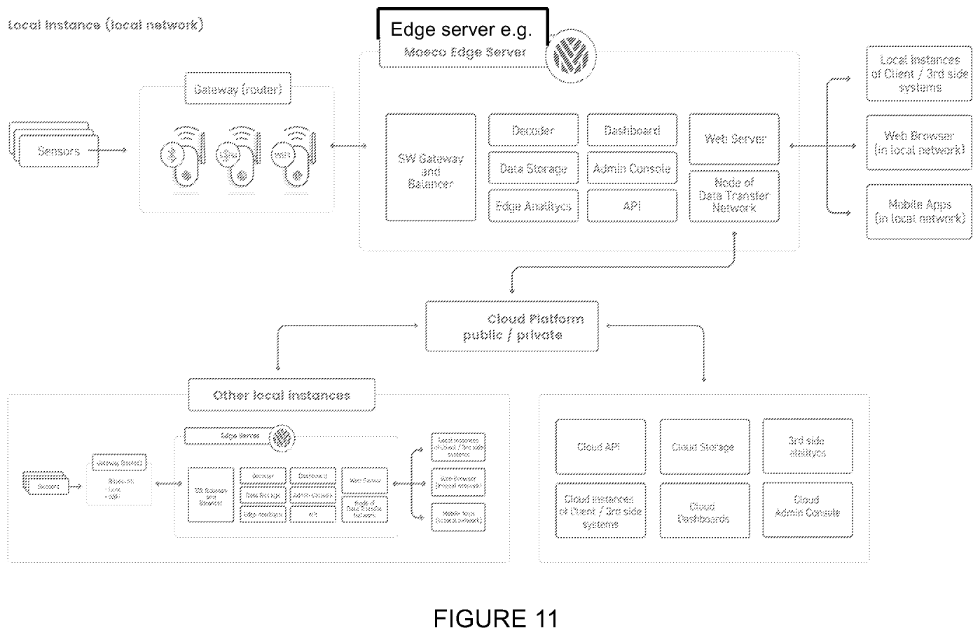

FIG. 11 shows a diagram of a software platform, e.g. a Moeco software platform, example.

Deployment Options

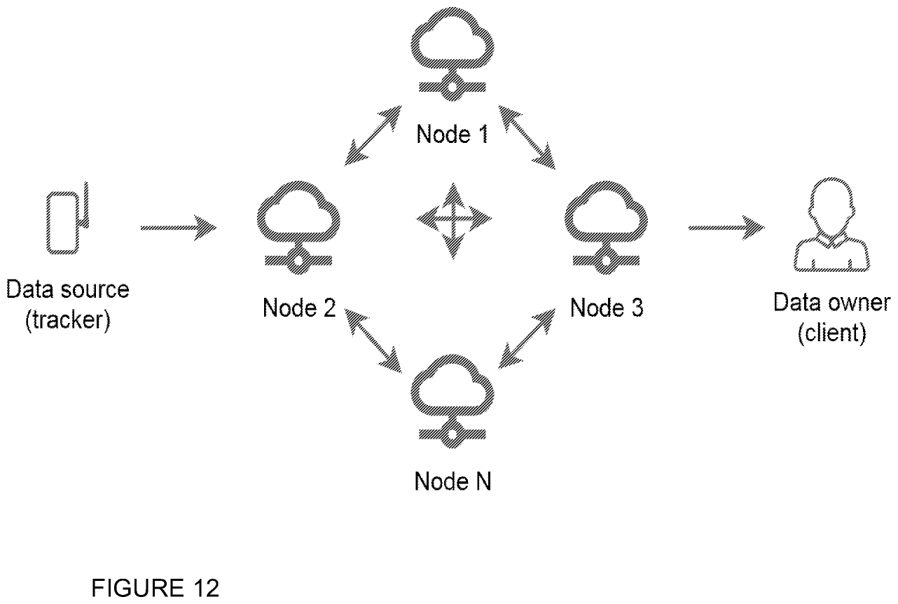

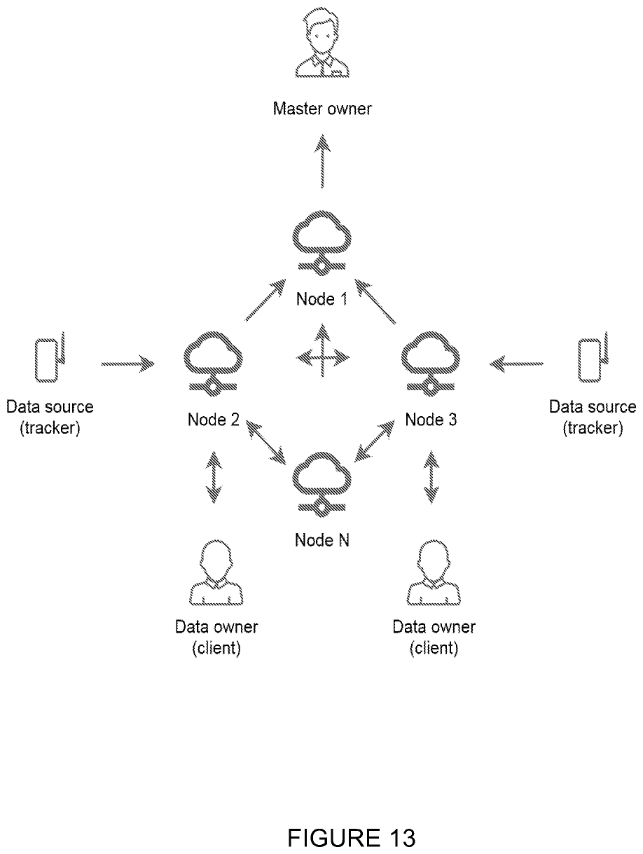

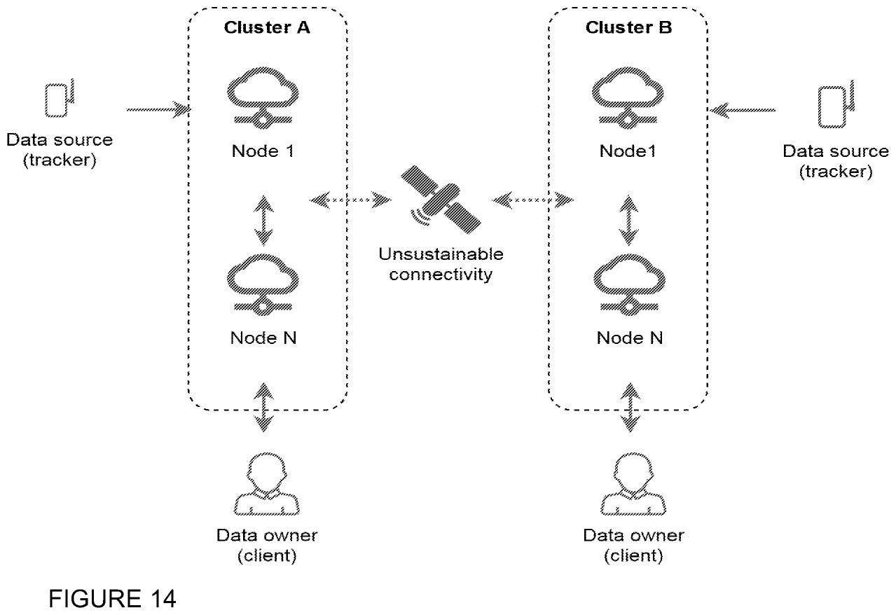

In an example, the architecture of the (e.g. Moeco) platform is designed to provide the most flexible options for configuring placement depending on the use case.
Peer-to-peer distributed network. Each node can receive data and synchronize it with everyone else. The owner of the data can contact any of the nodes and get the data. Suitable for deploying a global public (e.g. Moeco) network that includes many customers, suppliers and data consumers. FIG. 12 shows a diagram of a Peer-to-peer distributed network example.
Private distributed network. Each node can receive data and synchronize it with everyone else. The main owner can contact any of the nodes and get the data (e.g. all the data). Suitable for deployment at a large corporate client with separation of data usage levels. FIG. 13 shows a diagram of a Private distributed network example.
Several local clusters or regional networks work independently for a while, and then from time to time synchronize data (e.g. all data) with each other. Suitable for deployment in isolated, geographically dispersed divisions of the company that do not have a permanent connection to each other. FIG. 14 shows a diagram of a Network of isolated clusters example.

The (e.g. Moeco) Platform's Components

In an example, a Data Transfer Network is responsible for collecting, synchronizing and storing immutably transferred encrypted transactions (e.g. all the transferred encrypted transactions). Metadata (e.g. all the metadata) such as the list of the sensors identified by their IDs, settings, list of the gateways etc. are managed, synchronized and stored here as well.

A Data Transfer Network typically includes one or more, or all, of:
Blockchain Nodes;
Regular data storage;
Administrative console.

Blockchain Nodes are the main immutable storage for the transactions, metadata and change logs. This typically includes embedded smart contracts, validation of signatures and metadata of the transactions as well as rights to make any changes with metadata. There might be from just one to hundreds of (e.g. EOS) Blockchain nodes in order to provide horizontal scalability and sustainability.

Regular data storage gets the data from the Blockchain and stores them to allow to execute complex Structured Query Language (SQL) queries in order to provide necessary information and statistics for the Administrative Console.

In an example, an administrative console is a WEB application that provides functionality of managing and maintaining metadata (e.g. all the metadata), monitoring and visualization of the statistics. In an example, an administrative console doesn't have decryption keys so it doesn't have access to the data from the sensors inside the transaction's payload.

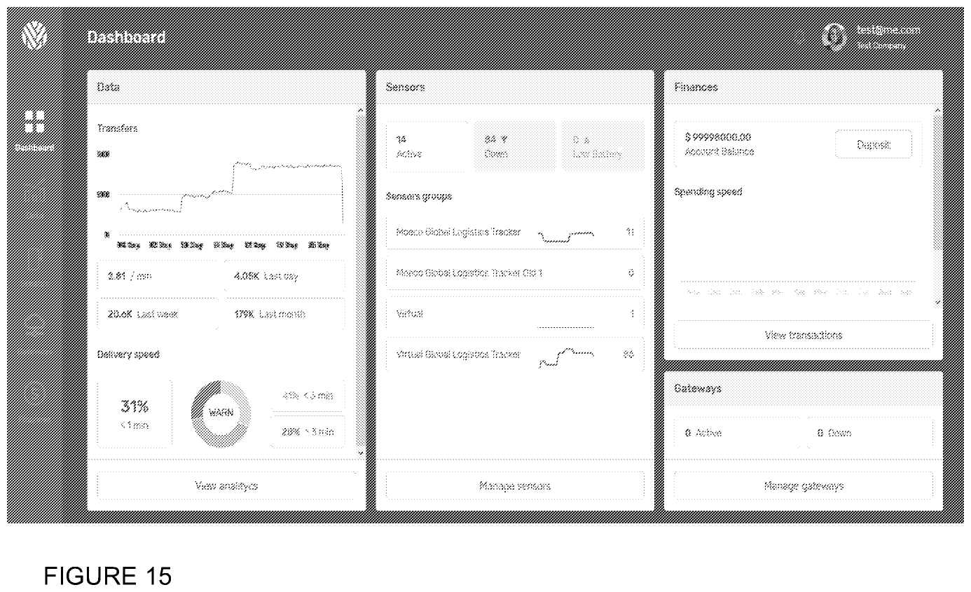

FIG. 15 shows an example of an administrative console main view, e.g. a Moeco administrative console main view.

In an example, a dashboard is a set of modules that in general are responsible for processing raw data from the sensors, aggregating them, analyzing, visualizing and sharing with necessary client or 3rd party (or “third side”) systems.

Dashboards may be deployed over the client secured infrastructure, in physical infrastructure, virtual infrastructure or cloud infrastructure as well as over (e.g. Moeco's) cloud.

A Dashboard Typically Includes One or More, or all, of:
Data Processor;
Dashboard WEB Applications;
Application Programming Interfaces (APIs).

In an example, a Data Processor is a software module that is responsible for payload decrypting, parsing data, data enrichment, and aggregation. For these purposes, the data processor implements a pipeline of services, each of which performs certain operations with the original data. In an example, or in examples:
The decryption service interacts with the key manager and decrypts the received payload.
The decoding service uses the set of rules specified for this type of tracker, and parses the received messages e.g. codograms.
The data enrichment service supplements the records with data obtained from other sources, for example, the exact geographic coordinates or the number and name of the zone on the site.
The event detection service may analyze the received data for compliance with one or several alert rules.
The aggregation service may prepare and save data in such a way that it is convenient to use it for quick multiple reading and analytics.

Dashboard WEB Applications are WEB applications that provide access to the data for clients and\or end customers.

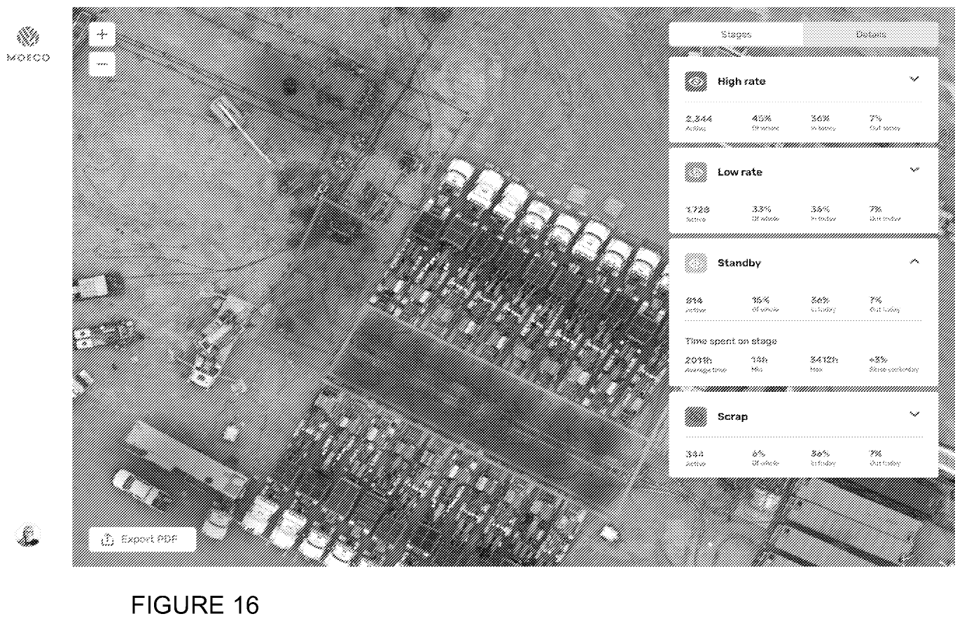

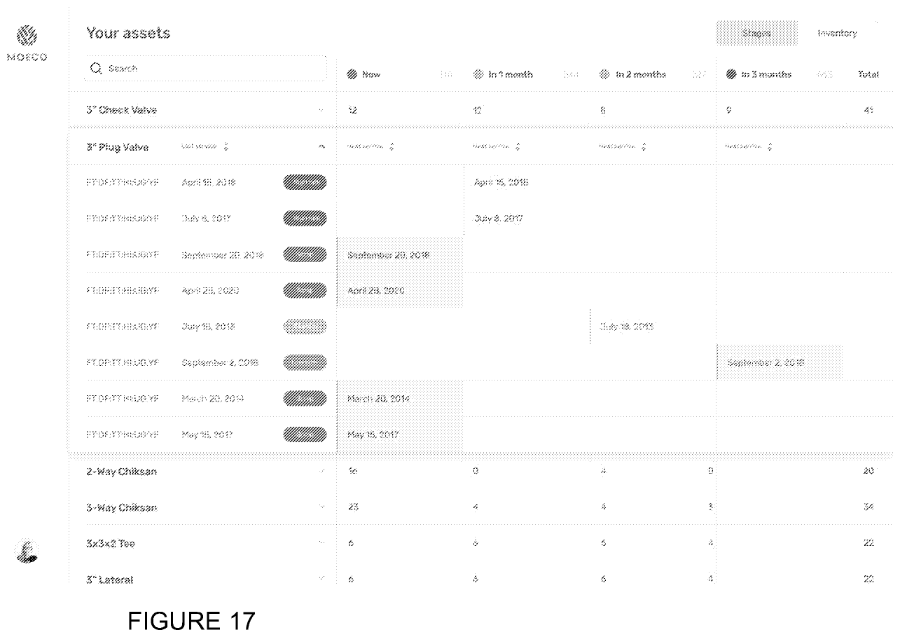

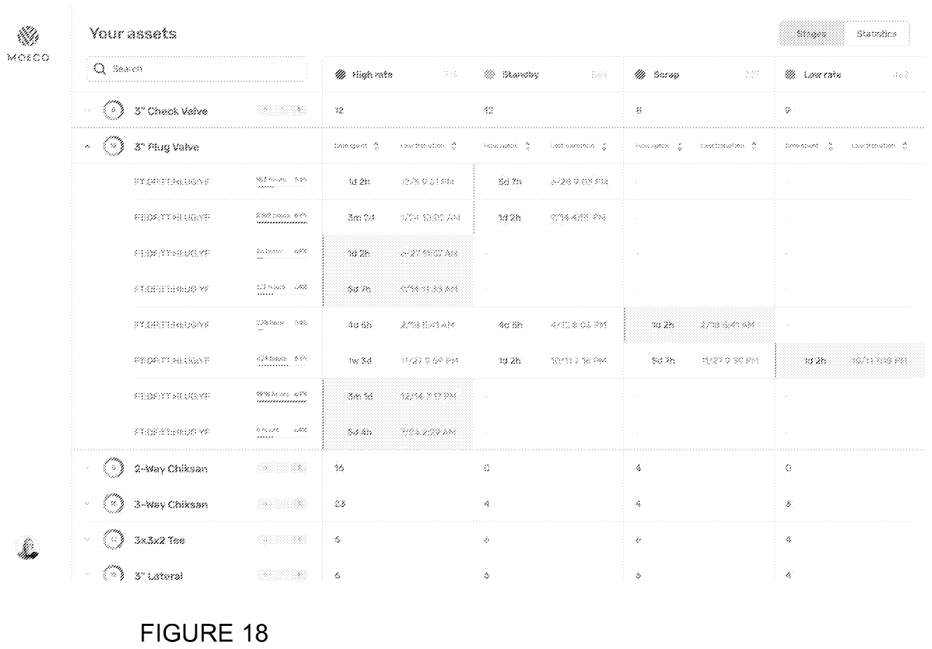

An Asset (or object) Tracking dashboard (e.g. a Moeco Asset (or object) Tracking dashboard) application may provide the user with some or all of the following information:
Layout of zones and assets (or objects) on the location plan and/or map. Location of zones and beacons can be adjusted here as well.
A list of stages in the life cycle of an asset (or object) and basic statistics about the number of assets (or objects) in these stages and their movements between stages. FIG. 16 shows an example of a location map and main statistics view.
Inventory list of assets (or objects) (e.g. all assets (or objects)) located in the location by their type, along with available information (e.g. all available information), such as the planned and current date of maintenance. FIG. 17 shows an example of a smart inventory view.
Distribution of assets (or objects) to different stages of the life cycle, along with information about the current state and time and mode of use at each stage. FIG. 18 shows an example of a life cycle stages statistics view.

In an example or in examples, APIs are applications that provide access to the data for client's internal or 3rd party systems. Our (e.g. Moeco) APIs support the most popular protocols such as Representational state transfer (REST) over Hypertext Transfer Protocol Secure (HTTPS) and/or MQTTS and are ready to support almost any necessary standard or custom protocols. (MQTT is a lightweight, publish-subscribe network protocol that transports messages between devices. The protocol usually runs over TCP/IP, however, any network protocol that provides ordered, lossless, bi-directional connections can support MQTT. MQTT is designed for connections with remote locations where a resource constraint(s) exist or the network bandwidth is limited. The protocol is an open OASIS standard and an ISO recommendation (ISO/IEC 20922)).

Asset (or object) Tracking workflow, e.g. Moeco Asset (or object) Tracking workflow Working with assets (or objects) and trackers may consist of, or comprise, several stages:
Initial tagging
Regular collection of information
Finding an asset (or object) at a location
Tracker replacement.

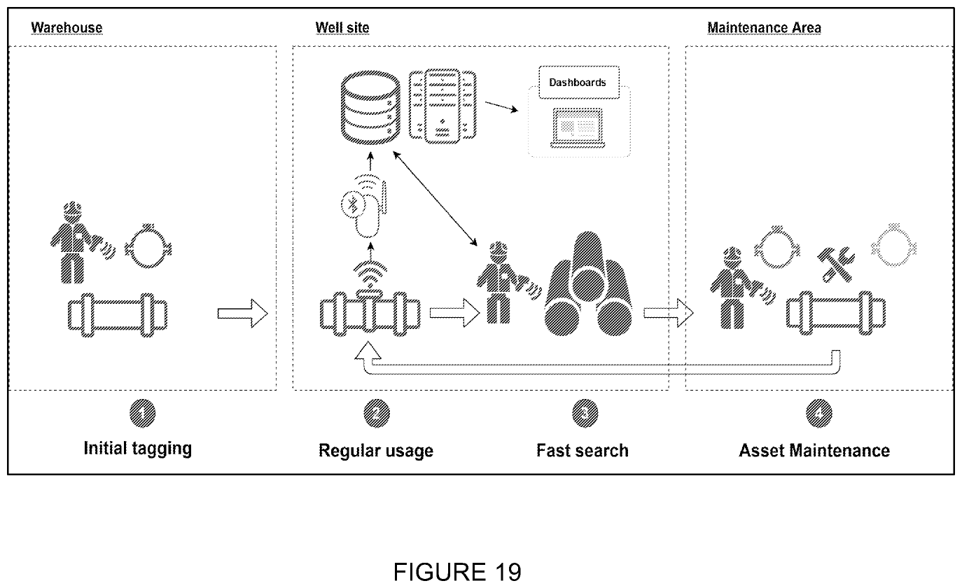

FIG. 19 shows an example of an asset (or object) tracking workflow.

During initial tagging, trackers may be attached to assets (or objects). Next, the RFID, NFS, QR or Barcode of the tracker may be scanned using a portable device e.g. smartphone executing a smartphone application, or a handheld RFID scanner, or a scanner of the portable device. The serial number (SN) of the asset (or object) itself, if any, is also indicated, otherwise the SN is created automatically. Additional information about the asset (or object), such as its type, size, valid usage parameters, etc. may be pulled from the client's information system or entered in the same application. Data (e.g. all data) may be stored on the platform.

Once attached, the trackers begin periodically collecting data about beacons around, and sensor data, e.g. temperature, vibration, etc. and in accordance with the established schedule send them to the platform along with the identifier of the tracker itself. On the platform, received data (e.g. all received data) is matched against the SN of the asset (or object) and any other information about it obtained during the initial tagging.

A portable device, e.g. smartphone, or hand-held scanner, or a portable device including a scanner, executing an (e.g. Moeco's) application, can be used to quickly find the desired asset (or object) on the site, as well as providing a mobile dashboard for quickly obtaining information about the asset (or object).

During any service operations, the tracker can be removed from the asset (or object). In this case, its ID is scanned and after completion of servicing, the ID of the same or a new tracker is re-bound to the asset (or object). Thus, regardless of whether the same or a new tracker is used, it will be tied to the same SN of the asset (or object) and the platform will be able to correctly match the new tracker with the entire previous history of the asset (or object).

Asset (or object) Tracking Analytics and AI options, e.g. Moeco Asset (or object) Tracking Analytics and AI options

In an example, during the entire period of use, the (e.g. Moeco) platform collects and accumulates a large amount of different data from trackers (e.g. all trackers), such as operational modes, usage time in different stages, sequence of transitions between stages, vibration and temperature data, etc. These collected data (e.g. all these collected data) can be used for further analytics.
Anomaly detection. The data (e.g. sensor data) received from the tracker may be compared with previously received templates from trackers on the same type of asset (or object) in the same modes of use. Large deviations can indicate anomalies and trigger an alert.
Early prediction of damage or significant reduction of asset (or object) lifetime. The information obtained during the regular manual maintenance operations performed on the assets (or objects) may be used for automatic data mapping. Subsequently, anomalies similar to those identified during the examination can be detected automatically during the use of the asset (or object) based on the data (e.g. sensor data) received from the tracker.

### Example Tracking System

An example tracking system includes equipment of several types and may cover a wide variety of use cases. An example tracking system includes a platform, a plurality of data loggers and a plurality of gateways. In an example tracking system, each data logger and each gateway is fully autonomous; in an example, adjacent devices do not produce any changes to each other's algorithms. For example, while transferring the data to a gateway, a data logger continues logging new data to its nonvolatile memory, and a gateway cannot make any alterations to that process except for cases where such alterations are configured on the platform.

A data logger can be manufactured in various form-factors: e.g. adhesive label, plastic tie, etc. The device's form factor doesn't affect its operation algorithms but can impose some limitations on the self-contained power supply capacity due to device dimensions. The primary purpose of a data logger is to collect and log into its nonvolatile memory data from its built-in sensors, such as a temperature sensor, light sensor, humidity sensor, acceleration sensor(s), etc. A data logger has the wireless connectivity for transferring data to a gateway, which, in its turn, transfers that data to the platform. Depending on a data logger model and form factor, data can be transferred via e.g. Bluetooth Low Energy (>4.0) and/or Bluetooth Low Energy Coded PHY (long-range).

In an example, a gateway serves as a bridge between a data logger and the platform and isn't involved in the data processing. In an example, the gateway's primary purpose is to scan for available Bluetooth connections and retrieve as much data as possible from the data logger devices in its Bluetooth range. A gateway may add position data obtained by scanning for WiFi/Mobile networks or via a built-in GNSS (GPS) receiver to all of the data received. Collected data is transferred from a gateway to the platform (e.g. immediately) once the stable Internet connection is established; otherwise, data is stored in the gateway built-in memory until establishing the stable Internet connection, after which the collected data is transferred from the gateway to the platform. In an example there are several Internet connectivity channels available to the gateway: e.g. WiFi, Ethernet, Mobile network. In an alternative, a gateway can be replaced by a mobile app providing the same functionality installed on and executing on a smartphone with Bluetooth Low Energy support.

In an example, a Global Tag is a standalone device combining the functionality of both a data logger and gateway. A Global Tag can be manufactured in various form-factors (e.g. adhesive label, plastic case, etc.) and may implement different powering systems (e.g. rechargeable, non-rechargeable, single-use power supply, solar-cell array, etc.).

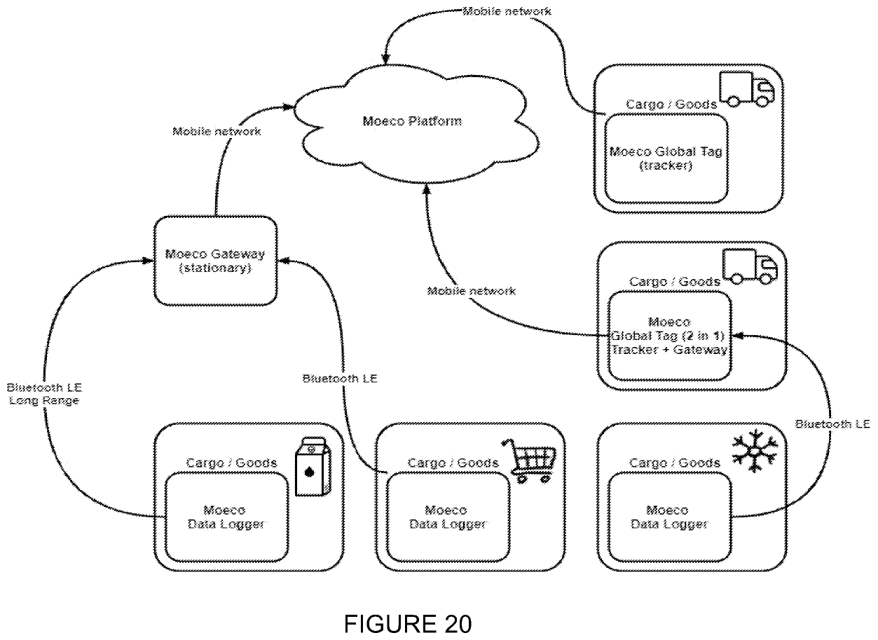

In an example system use case, there are several cargo units, most of which are equipped with data loggers, except for one equipped with a Global Tag. All the time those cargo units are located in one place, the Global Tag collects the data from the Data Loggers and transfers that data to the platform along with the data collected from its own built-in sensors. Then, when the cargo units are shipped to different locations and some data loggers are, as a result, transported away from the Global Tag, a gateway located at the destination depot retrieves the data the data loggers have collected while being not able to connect to a Global Tag, and transfers that data to the platform. FIG. 20 shows an example tracking system.

### An Example Data Logger (e.g. a Moeco Data Logger)

### Example Device Overview

In an example, a data (eg. including Bluetooth BT functionality) logger is a device aimed at monitoring conditions of cargo storage and transportation and the condition of the cargo itself. The device may be designed to be attached to a plain surface of cargo, or to a shipping package, or to an item-specific envelope.

### Example Device Features

The device may be equipped to monitor and to log one or more, or all, of the following parameters:
   Ambient temperature
   Relative humidity (optional)
   Cargo position in space
   Shocks count
   Light intensity (optional)
The device includes a self-contained power supply
The device includes a built-in real-time clock
The device may provide one-time use

Once activated, the device reads and records into its memory values of the parameters mentioned above measured by (e.g. built-in) sensors along with the corresponding timestamp according to the built-in real-time clock. The data log can be retrieved e.g. using a companion mobile app, or a (e.g. mobile) app of a dedicated router, via Bluetooth.

### Example Data Logger Functional Capabilities

1. Controlling the built-in battery charge level by measuring voltage level.
2. Synchronizing the built-in real-time clock in the service mode.
3. Logging sensors' measurement data: e.g. acceleration, temperature, humidity (optional), light intensity (optional) with a timestamp (e.g. in seconds).
4. Transferring the data to the (e.g. Moeco) platform using the (e.g. Moeco) platform data transfer protocol.
5. Data protection with encryption technology support.
6. Over the Air (OTA) firmware update.
7. Cyclical data logging: if the device memory is full, new values are written over the oldest ones.
8. Protection of the device firmware against reading via the debug interface or device service connector.
9. Self-test functionality for checking the performance of the built-in sensors and other components.

### Example Device Operation

The device may be configured to operate in several different modes, including one or more, or all, of:
Service mode
Storage mode
Active mode
Emergency mode
Disposal mode

The device may be controlled (e.g. turned on) by using a tact switch, or via the (e.g. Moeco) platform, or e.g. by removing a battery pull tab.

1. Service Mode

In an example of the service mode, self-tests or firmware updates may be performed. When switching to the service mode, the device may run a self-test to check the battery charge level and the performance of major components.

If the self-test shows any issues, the device sends the error code or any other issue info to the service mobile app or the corresponding app of the test stand at the place of manufacturing.

After running the self-test, the device waits for synchronizing the built-in real-time clock and OTA firmware update.

The device can be switched to the service mode from the storage mode only. To switch the service mode on, the device operator should e.g. press and hold the tact switch for at least 20 seconds but no longer than 25 seconds.

Switching to the service mode is indicated by light indication.

Service mode switches off when:
The device operator presses and holds the tact switch e.g. for at least 3 seconds but no longer than 8 seconds;
No interactions with the device are performed for a minute or longer;
Device firmware is updated successfully.

When the service mode turns off, the device switches to the storage mode.

2. Storage mode

In an example, the device may be in storage mode while supplied to a customer and/or stored at the customer's site.

In storage mode, the device is inactive. The device can be switched to the storage mode only at the completion of the entire manufacturing stage.

From the storage mode, the device can be switched to the active mode e.g. only, by removing the battery pull tab.

3. Active Mode

In an example active mode, the device logs the parameters of e.g. cargo storage and transportation, measured by the built-in sensors. The device, at specified intervals (T1), retrieves the measurement data from the built-in sensors and logs that data to its internal memory with a corresponding timestamp (e.g. in seconds).

Also, the device periodically (at T2 intervals) sends Bluetooth (e.g. advertisement) packets for establishing the connection and transferring the data log to the (e.g. Moeco) platform using the (e.g. Moeco) platform data transfer protocol.

The device is switched to active mode e.g. once the battery pull tab is removed from its enclosure.

Active mode can be switched off e.g. only by the command sent from the (e.g. Moeco) platform after the whole data log is transferred to the (e.g. Moeco) platform. In case the device is withdrawn from the e.g. cargo packaging or envelope at the end of cargo transportation, but no command from the (e.g. Moeco) platform is received, the device stays in active mode with light indication disabled.

The device can be switched only to the disposal mode from active mode by erasing the device memory by overwriting all values.

4. Disposal Mode

In an example disposal mode, the device should be deactivated and show no activity. From an example disposal mode, the device cannot be switched to any other mode.

The device can be switched to the disposal mode only by the command sent from the (e.g. Moeco) platform.

### Example Data Logger Device Construction

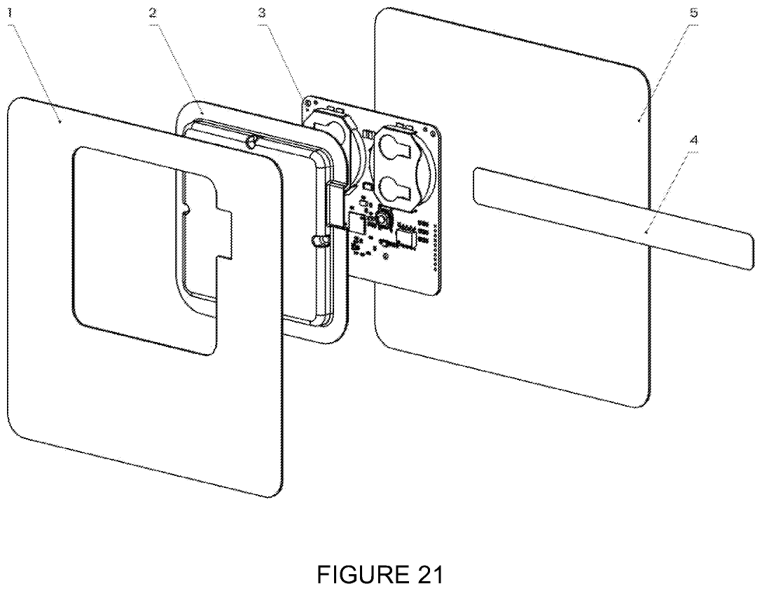

1. An example data logger device is designed in a form-factor of a stick-on label. (See FIG. 21, for example)
2. The device can be mounted to a plain moistureless surface of a shipping package or postal envelope (e.g. ISO 269).
3. The device may be activated by removing the battery pull tab (4) of the device's enclosure.
4. The device should not require forced cooling.

A Global Tag Device (e.g. Moeco Global Tag)

### Example Device Overview

The device product “Global Tag” is designed to track the location, storage conditions, transportation conditions and condition of cargo.

### Example Advantages and Features

Determination of the cargo location
Location triangulation by cellular network (e.g. GSM) base stations
Location determination by Wi-Fi access points
Control of cargo parameters. Recording and storage in non-volatile device memory
Ambient temperature measurement and recording
Environmental humidity measurement and recording
Position in space, measurement and recording
Shock recording
Ambient light measurement and recording
Built-in SIM card
Passive NFC tag
Self-contained power supply
Vandal resistant design
Multiple use

### Example Functional Capabilities

1. The device includes a battery and has the function of monitoring the charge level of the battery.
2. The device includes a built-in real time clock and supports the function of synchronizing the built-in real time clock with the cellular network (e.g. GSM) service or with one of the (e.g. Network Time Protocol (NTP)) servers for each successful attempt to connect to the (e.g. Moeco) platform.
3. The device has the function of recording the data read from the sensors: e.g. acceleration, temperature, humidity, light, tamper, with the addition of a timestamp and a serial number of the recording in a non-volatile memory.
4. The device transmits the data to the (e.g. Moeco) platform in accordance with the (e.g. Moeco) platform's data transmission protocol.
5. The device transmits data to the (e.g. Moeco) platform in the secure way with data encryption technology.
6. Device supports software update function via service connector in service mode.
7. Device supports software update function via GPRS connection on command from (e.g. Moeco) platform.
8. The device supports the function of unscheduled communication with the (e.g. Moeco) platform on the following events:
   Tamper sensor actuation
   Shock sensor triggered above permissible threshold X2
   Temperature sensor triggered above permissible threshold T2
9. Writing parameters to the non-volatile memory of the device is cyclic. In case of an overflow, new values are written over the previous ones.
10. The device software is protected against reading through the debug interface and the service connector of the device.
11. The device has a self-diagnostic function with which to determine the operability of built-in elements and sensors.

### Example Device Operation

The device may operate in several modes:
Service mode
Storage mode
Active mode
Emergency mode
Charging mode

The device may be controlled via the clock button, or from the (e.g. Moeco) platform or the service interface (only in service mode).

1. Service Mode

In an example, the service mode is used for the period of service maintenance or software update of the device.

When entering the service mode, the device goes through self-diagnostics: check the battery charge level, check the availability and operability of the main assemblies, check the tamper switch. If the self-test detects an anomaly, the device records the event in the non-volatile memory and transmits it to the (e.g. Moeco) platform. If it is not possible to write to the non-volatile memory, the device goes into the emergency operation mode. After the self-diagnostic process, the device switches to waiting for the software update process.

Switching to the service mode is done only from the storage and charging modes in one of the following ways:
By holding down the device button e.g. for at least 20 seconds and no more than 30 seconds
Through the debugging interface of the device
Command from the (e.g. Moeco) platform

The entering of the service mode may be confirmed by a yellow light-emitting diode being illuminated.

To exit the service mode you can do one of the following:
Holding down the device button e.g. for at least 10 seconds and no more than 20 seconds
Through the debugging interface of the device
No action for more than e.g. 1 minute
Successful software update of the device

Exit from the service mode is carried out e.g. to the previously used operating mode of the device.

2. Storage Mode

In an example, the storage mode is used for the period of transportation of the device to the customer after the production phase or for the period of storage of the device by the customer. The main purpose of this mode is to ensure energy efficiency for the entire period of use of the device.

Switching to storage mode from active mode is only done by command from the (e.g. Moeco) platform. This may be confirmed by an indication.

Exit from storage mode may be to any of the other modes.

3. Active Mode

In an example, the active mode is the main operational mode for tracking the location, storage conditions, transportation conditions and condition of the cargo.

In an active mode example, the device periodically with the period T1 collects data from the onboard sensors, with the period T4, a multiple of T1, scans active Wi-Fi access points and records the accumulated values into the non-volatile memory of the device with the addition of a time stamp. Periodically with a period T2 during the period T3, the device connects to the cellular network to transfer the accumulated data from the non-volatile memory of the device, including a list of serving and available cellular cells, to the (e.g. Moeco) platform in accordance with the (e.g. Moeco) platform data transfer protocol.

If the data transfer to the (e.g. Moeco) Platform is successful, the data is deleted from the non-volatile memory of the device.

In case of critical values received from the sensors, the device is immediately connected to the cellular network for a period of T3. In case of unsuccessful connection, a retry is made after the period T5.

Switching to the active mode is performed e.g. only by holding down the device button for at least 3 seconds and no more than 10 seconds.

The transition to the active mode may be confirmed by the green indication of the LED.

Exiting the active mode may be done in one of the following ways:
A command through the debug interface of the device
Command from the (e.g. Moeco) platform

Exit from the active mode is carried out e.g. only in standby mode through the procedure of complete erasure of the non-volatile memory of the device by overwriting all values.

4. Emergency Mode

In an example, the emergency mode informs the customer or the factory of the further impossibility to operate the device. If the tracker enters this mode, it should be sent to the factory for further recovery or disposal procedures.

The transition to the emergency mode may carried out after the following events:
Opening of the device case, accompanied by the process of clearing the non-volatile memory of the device by overwriting all the values, or
Error of data recording into the non-volatile memory of the device.

Exit from the emergency mode is impossible.

5. Charging Mode

In an example, the device is in charging mode only when connected to a charging base station or to a charging individual adapter. In this mode, all main peripheral modules may be switched off in order to save the energy of the built-in battery.

Switching to the charging mode is carried out from any of the modes, except emergency mode, by the presence of power supply voltage on the contact group of the device body.

When switching from the active mode, the device must be connected to the cellular network for a suitable time in order to transfer the accumulated data from the non-volatile memory of the device, and the list of serving and available cellular cells, to the (e.g. Moeco) platform in accordance with the (e.g. Moeco) platform data transfer protocol.

If the data transfer to the (e.g. Moeco) Platform is successful, the data is deleted from the device's non-volatile memory and the device enters charging mode.

In case of an unsuccessful connection, an attempt is made again after a period of T5. The number of attempts is limited to Y times. If Y times are exceeded, the data is deleted from the non-volatile memory of the device and the device enters the charging mode. In an example, exit from the charging mode is performed only to the storage mode.

### Example Construction

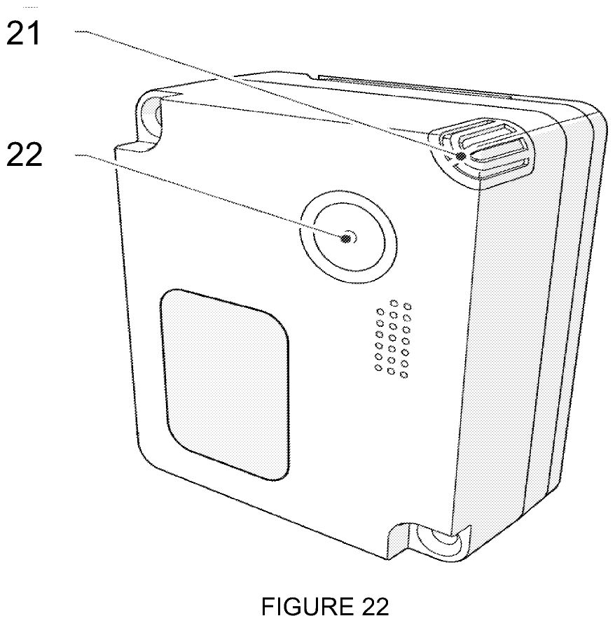

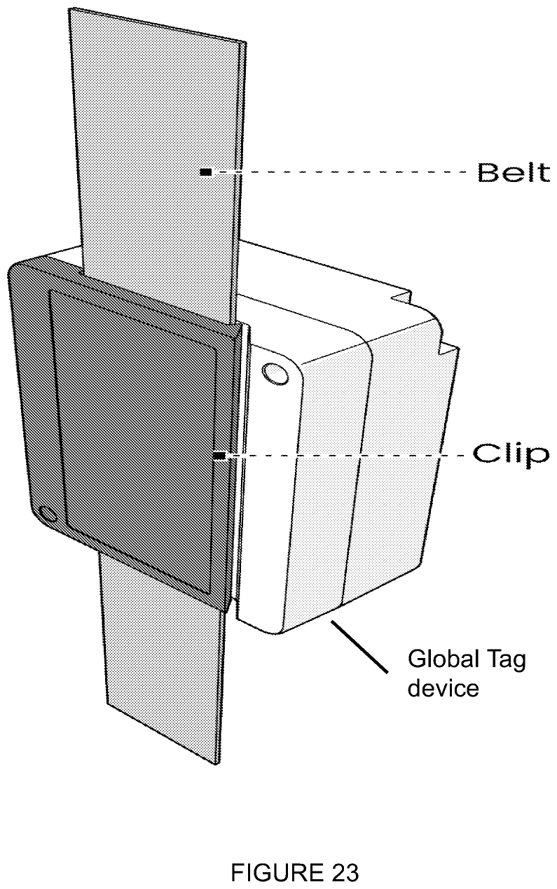

1. The device has the following example mounting options:
   To the surface of the shipping container (e.g. ISO 445:2013)
   To the polypropylene packing tape (e.g. EN 13394:2001)
   See e.g. FIG. 23.
2. Light indication of operating states of the device (see e.g. FIG. 22), in which the light indicator (21) is:
   Green, or
   Red, or
   Yellow.
3. Mechanical activation should be done by pressing the button (see e.g. FIG. 22).
4. The device does not require forced cooling.
5. The device has a contact group and attachment system for connecting to a charging base station or to a charging individual adapter.
6. The device has a mechanical tamper switch
7. The life span of the components is not less than 5 years.

A Gateway (e.g. Moeco Gateway)

### Example Device Overview

In an example, this is a decentralized data collection system for collecting data from (e.g. Moeco) peripheral devices via the Bluetooth LE wireless data transmission channel to the (e.g. Moeco) platform server. The gateway is mounted on a stationary or dynamic object with a predefined Bluetooth coverage area. It is available in several versions for indoor and outdoor use, if desired. Does not require periodic maintenance or user/operator monitoring during operation.

### Example Functional Capabilities

1. Gateway provides data reception via Bluetooth LE wireless channel with Long Range (Coded PHY) technology
2. Gateway provides data transfer to the (e.g. Moeco) server via wireless Wi-Fi and LTE or wired Ethernet links.
3. Gateway supports real time clock synchronization with several NTP servers (e.g. two by default).
4. Gateway has a backup storage function of the data transferred in case there is no connection with the (e.g. Moeco) server until the (e.g. Moeco) server confirms that it has received the data successfully.
5. Gateway supports remote control with protection against accidental or intentional interference.
6. Gateway supports the logging of system messages and the ability to transmit them to the platform on demand.
7. Gateway supports remote updates.
8. Gateway supports redundant power supply system to detect and prevent unexpected power outage.

### Example Device Operation

The device may operate in several modes:
Storage mode
Configuration mode
Active mode
Shutdown mode

1. Storage Mode

In an example, in this mode the Gateway is stored in storage or transported to the point of use. The Gateway is equipped with the real-time clock and backup power system at the manufacturer's factory. The Gateway can remain in storage mode for e.g. up to one calendar year, during which the built-in backup power supplies do not lose more than 50% of their nominal capacity.

Exiting storage mode is achieved by supplying power e.g. to an Ethernet PoE connector.

2. Configuration Mode

In an example, in configuration mode a WEB interface is available on the Gateway to configure the necessary parameters of the Gateway. Alternatively you can upload a settings file to the Gateway. Resetting is done e.g. by long pressing the “reset” button and is confirmed by corresponding indication. Access to the WEB interface should not be more than the first e.g. 10 minutes after power up. The configuration mode may start in parallel to the active mode.

Parameters entered in configuration mode are stored in the Gateway's non-volatile memory until forced reset to “default” parameters.

If the Gateway was configured specifically for a particular customer, such parameters become the “default” parameters.

3. Active Mode

In an example, in this mode the Gateway periodically scans the Bluetooth LE, searching for other (e.g. Moeco) devices with the consideration of filtering rules specified in the configuration file or WEB interface. The Gateway connects to the first device in the list and according to the (e.g. Moeco) data transfer protocol and reads the accumulated data into the non-volatile memory in case of no connection to the (e.g. Moeco) platform or transmits the data immediately to the platform using the Gateway RAM.

The connection to the platform is confirmed by a corresponding indication.

When the data transfer is complete, the device is added to the waiting list for a period of time specified in the configuration file or in the Gateway WEB interface.

4. Shutdown Mode

In an example, if there is no power to the gateway, the gateway enters shutdown mode. In this mode all active connections are terminated and data is stored in non-volatile memory of Gateway. Gateway stops all processes and enters storage mode. Shutdown mode is accompanied by corresponding indication.

### Example Construction

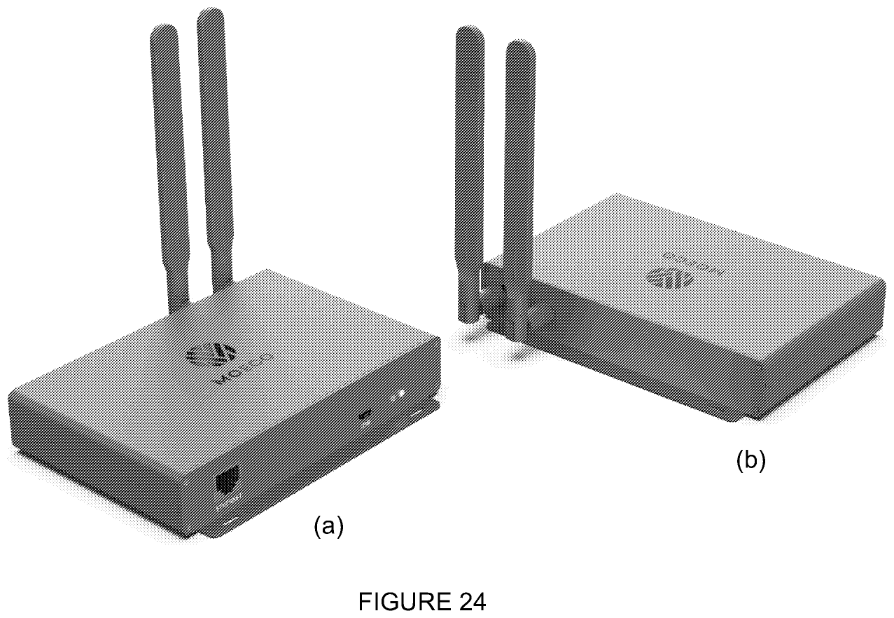

1. Functional parts of the Gateway must be designed to prevent incorrect installation and activation (see e.g. FIG. 24).
2. The Gateway should not require forced cooling.
3. The Gateway enclosure is ingress protection (eg. IP68) rated for dust and moisture protection.
4. The Gateway enclosure is vandal-resistant.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A system for tracking a plurality of objects, the system including a server system, a plurality of gateways and the plurality of objects, wherein each object of the plurality of objects includes a battery arranged to power the object, a non-transitory storage medium, an (e.g. unique) object ID stored in the non-transitory storage medium, a first transceiver and a second transceiver, wherein the second transceiver is different to the first transceiver, wherein the first transceiver of each object is arranged to communicate with a first respective gateway, and wherein the second transceiver of each object is arranged to communicate with a second respective gateway;
wherein each object of the plurality of objects includes one or a plurality of sensors and is configured to sense and to transmit sensory data, wherein the server system is configured to receive transmissions of the sensory data from each respective object via any gateway of the plurality of gateways, the transmissions including a respective object ID of a respective object, and a gateway ID of a gateway which receives the transmission from the respective object and which sends the transmission to the server system;
wherein the server system is configured to store a tracking record of each respective object in association with the respective object ID, wherein the server system is configured to update the stored tracking record of the respective object, in response to receiving a respective communication from the respective object, the update including the sensory data and location data of the respective object;
wherein the server system is configured to derive the location data of the respective object using at least a gateway ID included in the received communication from the respective object.

2. The system of claim 1, (i) wherein the first transceiver is arranged to communicate with the first respective gateway over a distance up to at least 20 m; or (ii) wherein the first transceiver is a Bluetooth transceiver or a Bluetooth Low Energy transceiver; or (iii) wherein the first transceiver is arranged to communicate with the first respective gateway over a distance up to at least 1.0 km; or (iv) wherein the first transceiver is a Bluetooth Long Range transceiver.

3-5. (canceled)

6. The system of claim 1, (i) wherein the second transceiver is arranged to communicate with the second respective gateway over a distance up to at least 10 km; or (ii) wherein the second transceiver is a LoRa (Long Range) transceiver; or (iii) wherein the second transceiver is a cellular transceiver and the second respective gateway is a cellular gateway; or (iv) wherein the second transceiver is a cellular transceiver and the second respective gateway is a cellular gateway, and wherein the cellular transceiver and the cellular gateway technology is 2G(GPRS), or 3G, or NarrowBand-Internet of Things (NB-IoT), or LTE Cat. M ((Long Term Evolution for Machines—low power wide area (LPWA))), or 5G.

7-9. (canceled)

10. The system of claim 1, wherein each object includes a unique object ID and can be identified through an included identifier which is an included Radio-frequency identification (RFID) tag, or an included NFC tag, or an included Quick Response code (QR code) or an included barcode, wherein the included identifier includes the unique object ID.

11. The system of claim 1, wherein the objects each include a temperature sensor, the sensory data includes temperature data measured using the temperature sensor, and the update includes the temperature data of the respective object.

12. The system of claim 1, wherein the objects each include a light sensor, the sensory data includes light exposure data measured using the light sensor, and the update includes the light exposure data of the respective object.

13. The system of claim 1, wherein the objects each include a noise sensor, the sensory data includes noise data measured using the noise sensor, and the update includes the noise data of the respective object.

14. The system of claim 1, wherein the objects each include an accelerometer sensor, the sensory data includes vibration data measured using, or derived from, the accelerometer sensor, and the update includes the vibration data of the respective object.

15. The system of claim 14, wherein the sensory data includes sensory data derived from the accelerometer sensor which is Fast Fourier Transform of vibration data measured using the accelerometer sensor.

16. The system of claim 1, wherein the objects each include a pressure sensor, the sensory data includes pressure data measured using the pressure sensor, and the update includes the pressure data of the respective object.

17. The system of claim 1, wherein the objects each include a water immersion sensor, the sensory data includes water immersion data measured using the water immersion sensor, and the update includes the water immersion data of the respective object.

18. The system of claim 1, wherein the server system is configured to analyze received sensory data of a respective object, and to determine whether to inspect, maintain or replace the respective object, and to record the determination.

19. The system of claim 1, wherein the server system includes a data collection, transmission and visualization platform, which also includes data orchestration, analytics and integration with other systems, and wherein the platform includes a visual editing tool, the tool operable to define zones, and operable to place one or both of directional and omnidirectional beacons, e.g. in a map or location plan.

20. (canceled)

21. The system of claim 19, wherein the tool is operable to define the place of beacons on a map or location plan, to include their geographic or relative coordinates, to define geofences, and to save this data in a (e.g. Moeco) geolocation service.

22. (canceled)

23. The system of claim 1, wherein the server system is configured to include a list of objects at a site, such as at a warehouse, at a construction site, or at a drilling site.

24. The system of claim 23, wherein the server system is configured to output positions of the objects in the list of objects, or wherein the server system is configured to output the usage of each object in the list of objects, for example using sensed vibration data.

25-27. (canceled)

28. The system of claim 1, wherein each object is customizable and includes multiple pads and/or connectors arranged to mount or to connect sensors, e.g. during tracker customisation.

29. The system of claim 1, wherein the plurality of sensors includes two or more of, or all of: (a) an Air/Surface temperature sensor; (b) a humidity sensor; (c) an accelerometer (e.g. for sensing Vibrational patterns, movements detection, orientation in space); (d) a Magnetometer (e.g. for sensing Direction of movement/facing); (e) a light exposure sensor; (f) an air pressure sensor; (g) a distance sensor; (h) a Secure seal.

30. The system of claim 1, wherein each object is configured to determine its location, for example using one or more of: (a) Global Positioning System (GPS)/Global navigation satellite system (GNSS) coordinates; or
(b) Triangulation by cellular network (e.g. GSM) Towers; or
(c) Triangulation through gateways locations; or
(d) WiFi or Bluetooth location-based service (LBS); or
(e) Bluetooth 5.1 Angle of Arrival (AoA) and/or Angle of Departure (AoD) calculating; or
(f) Bluetooth location beacons zoning (half-sphere and/or omnidirected); or
(g) RFID zoning.

31. The system of claim 1, wherein each object is configured to measure signals from a plurality of beacons, to determine the beacons' IDs and respective signal attenuation levels, and to transmit the determined beacons' IDs and respective signal attenuation levels to the server system, wherein the server system is configured to derive location data of the respective object using the transmitted determined beacons' IDs and the respective signal attenuation levels.

32. The system of claim 1, wherein the plurality of gateways are configured to receive the same signal from an object, and to determine a respective signal attenuation level, and to transmit the received signal and the determined respective signal attenuation level to the server system, wherein the server system is configured to derive location data of the respective object using the received signals and the determined respective signal attenuation levels.

33-36. (canceled)

37. The system of claim 1, wherein the server system stores the current state of the plurality of objects, and wherein the server system is configured to display a dashboard of the plurality of objects, showing the current state of the plurality of objects.

38-39. (canceled)

40. The system of claim 1, wherein the server system includes a Data Transfer Network which is configured to collect, synchronize and store immutably transferred encrypted metadata, such as a list of the sensors identified by their IDs that are sensed by the object, and/or object settings, and/or a list of the gateways sensed by the object.

41-44. (canceled)

45. The system of claim 1, wherein the server system is configured to output inventory lists of objects located in a location, by object type, along with available information, such as the planned date of maintenance of each object, and/or the previous date of maintenance of each object, and to display this information on an object tracking dashboard.

46. The system of claim 1, wherein the server system is configured to determine a distribution of objects at different stages of the object life cycle, along with information about the current object state and mode of object use at each life cycle stage, and to display this information on an object tracking dashboard.

47. A computer-implemented method for tracking a plurality of objects using a system, the system including a server system, a plurality of gateways and the plurality of objects, wherein each object of the plurality of objects includes a battery arranged to power the object, a non-transitory storage medium, an (e.g. unique) object ID stored in the non-transitory storage medium, a first transceiver and a second transceiver, wherein the second transceiver is different to the first transceiver, wherein the first transceiver of each object is arranged to communicate with a first respective gateway, and wherein the second transceiver of each object is arranged to communicate with a second respective gateway;
wherein each object of the plurality of objects includes one or a plurality of sensors and is configured to sense and to transmit sensory data;
the method including the steps of:
(i) each object sensing and transmitting the sensory data;
(ii) the server system receiving transmissions of the sensory data from each respective object via the first respective gateway, and via the second respective gateway, the transmissions including a respective object ID of a respective object, and a gateway ID of a gateway which receives the transmission from the respective object and which sends the transmission to the server system;
(iii) the server system deriving location data of the respective object using at least a gateway ID included in the received communication from the respective object;
(iv) the server system storing a tracking record of each respective object in association with the respective object ID, and updating the stored tracking record of the respective object, in response to receiving a respective communication from the respective object, the update including the sensory data and the location data of the respective object.

48-57. (canceled)

58. A system for tracking a plurality of objects, the system including a server system, a plurality of gateways and the plurality of objects, wherein each object of the plurality of objects includes a battery arranged to power the object, a non-transitory storage medium, an (e.g. unique) object ID stored in the non-transitory storage medium, and a transceiver, wherein the transceiver of each object is arranged to communicate with the gateways;
wherein each object of the plurality of objects includes one or a plurality of sensors and is configured to sense and to transmit sensory data, wherein the server system is configured to receive transmissions of the sensory data from each respective object via any gateway of the plurality of gateways, the transmissions including a respective object ID of a respective object, and a gateway ID of a gateway which receives the transmission from the respective object and which sends the transmission to the server system;
wherein the server system is configured to store a tracking record of each respective object in association with the respective object ID, wherein the server system is configured to update the stored tracking record of the respective object, in response to receiving a respective communication from the respective object, the update including the sensory data and location data of the respective object;
wherein the server system is configured to derive the location data of the respective object using at least a gateway ID included in the received communication from the respective object.

59-73. (canceled)
